(19) United States
(12) Patent Application Publication
(10) Pub. No.: US 2010/0036896 A1
(43) Pub. Date: Feb. 11, 2010

(54) Computer System and Method of Managing Backup of Data

(75) Inventors: Hirotaka Nakagawa, Sagamihara (JP); Masayasu Asano, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Lrd.

(21) Appl. No.: 12/236,537

(22) Filed: Sep. 24, 2008

(30) Foreign Application Priority Data
Aug. 8, 2008 (JP) 2008-205458

(51) Int. Cl. G06F 12/16; G06F 17/30

(52) U.S. Cl. 707/204; 707/E17.009

(57) ABSTRACT

A backup is continued in a computer system even one storage device is stopped. In the computer system, a first storage device, upon reception of a data write request to a first storage area, stores the data in the first storage area and a second storage area, and transmits the data to a second storage device. The second storage device stores the received data in a third storage area and a fourth storage area. The first storage device, upon reception of a snapshot creation request, suspends storing of the data in the second storage area, while the second storage device, upon reception of the snapshot creation request, suspends storing of the data in the fourth storage area at timing that the same data is stored in the second storage area and the fourth storage area, and after storing of the data is suspended, transmits an identifier equal to an identifier of the second storage area to an inquiry transmission source as an identifier of the fourth storage area.

### CROSS REFERENCES TO RELATED APPLICATIONS

This application relates to and claims priority from Japanese Patent Application No. 2008-205458, field on Aug. 8, 2008, the entire disclosure of which is incorporated herein by reference.

### BACKGROUND OF THE INVENTION

1. Field of the Invention

The present invention relates to a computer system and a method of managing backup of data, and more particularly to a backup of the computer system which makes use of a data copying technique and a technique for managing a path to access data.

2. Description of the Related Art

Conventionally, there has been a case that even a highly reliable storage device becomes inoperable or unusable due to an external cause such as a disaster or the like. To allow the storage device to continue the business even in such a case, for example, JP-A-2007-72538 (patent document 1) and JP-A-2008-134988 (Patent document 2) disclose a technique which duplicates data.

According to such a technique, by making use of a so-called remote copying technique which copies data stored in a volume in a storage device to a volume in a different storage device, data which a business server uses can be duplicated. The business server includes alternate path management software for managing switching of a plurality of paths for accessing one volume.

By using the same identifier for two volumes which store the duplicated data in the above-mentioned manner, the alternate path management software recognizes these two volumes as a single volume, and recognizes two paths for accessing these two volumes as two paths for accessing a single volume. In such a system, one of these two storage devices is stopped due to a disaster or the like, the alternate path management software detects the blockage of one of two paths to the storage devices and switches the access destination to another path.

In this manner, according to the technique disclosed in patent document 1 and patent document 2, even when one storage device is stopped due to a disaster or the like, the business is continued by automatically changing the path which the business server uses.

Further, there has been disclosed a technique in which two storage devices respectively create a copy of data at the same point of time (so-called snapshot) (see JP-A-2003-242011, for example).

According to such a technique, two storage devices respectively include volumes for duplicating business data. Here, the explanation is made with respect to a case in which two storage devices are respectively referred to as a primary storage device and a secondary storage device, the primary storage device includes a primary volume, and the secondary storage device includes a secondary volume. The primary storage device further includes a volume which stores the copy of data stored in the primary volume (referred to as local snapshot). On the other hand, the secondary storage device further includes a volume which stores the copy of data stored in a secondary volume (referred to as remote snapshot).

By matching timing at which copying of data from the primary volume to the local snapshot is stopped and timing at which copying of data from the secondary volume to the remote snapshot is stopped, it is possible to store the same data (that is, snapshot at the same point of time) in the local snapshot and the remote snapshot.

### SUMMARY OF THE INVENTION

By combining the technique disclosed in the above-mentioned patent document 3 with the technique disclosed in the above-mentioned patent document 1 or patent document 2, it is possible to create the snapshot having the same content in two storage devices while preventing the suspension of business due to a disaster or the like.

Further, there may be a case that a backup server is connected to the above-mentioned two storage devices, wherein the backup server prepares a backup of only one snapshot out of two snapshots. For example, the backup server may read data from the local snapshot and may store data in a magnetic tape or the like. However, when the primary storage device is stopped due to a disaster or the like during the preparation of such a backup, the preparation of the backup is suspended.

The present invention has been made to overcome such drawbacks of the related art and it is an object of the present invention to provide a computer system and a method of managing backup of data which can continue business without suspending backup even when one storage device is stopped due to a disaster or the like.

According to one aspect of the present invention, there is provided a computer system comprising:

a first storage device; and

a second storage device which is connected to the first storage device via a network, wherein

the first storage device includes one or more memory mediums each of which includes a plurality of storage areas for storing data, and a first controller which controls writing of data to the memory medium and reading of data from the memory medium,

the plurality of storage areas in the first storage device includes a first storage area and a second storage area,

the second storage device includes one or more memory mediums each of which includes a plurality of storage areas for storing data and a first controller which controls writing of data to the memory mediums and reading of data from the memory medium,

the plurality of storage areas in the second storage device includes a third storage area and a fourth storage area,

the first storage device is configured, upon reception of a data write request to the first storage area, to store data to which a write request is made in the first storage area, to transmit a copy of data to which the write request is made to the second storage device and to store the copy of data to which the write request is made in the second storage area,

the second storage device is configured to hold management information which contains information which makes an identifier of the first storage area and an identifier of the third storage area correspond to each other and information which makes an identifier of the second storage area and an identifier of the fourth storage area correspond to each other,

the second storage device is configured, upon reception of an inquiry of the identifier of the storage area, to transmit an identifier equal to the identifier of the first storage area as the identifier of the third storage area to the inquiry transmission source based on the management information,

the second storage device is configured, upon reception of copy of data to which the write request is made from the first storage device, to store the copy of data to which the write request is made in the third storage area and, further, to store the copy of data to which the write request is made in the fourth storage area,

the first storage device is configured, upon reception of a snapshot creation request which designates the first storage area and the second storage area, to suspend storing of the copy of data to which the write request is made in the second storage area,

the second storage device is configured, upon reception of a snapshot creation request which designates the third storage area and the fourth storage area, to suspend storing of the copy of data to which the write request is made in the fourth storage area at timing that a copy of the same data is stored in the second storage area and the fourth storage area, and

the second storage device is configured, upon reception of an inquiry of the identifier of the storage area after the suspension of storing of the copy of data to which the write request is made in the second storage area and the fourth storage area, to transmit an identifier equal to the identifier of the second storage area as the identifier of the fourth storage area to the inquiry transmission source based on the management information.

According to one aspect of the present invention, the business can be continued without suspending a backup even when one storage device is stopped due to a disaster or the like.

### BRIEF DESCRIPTION OF THE DRAWINGS

FIG. 1 is a block diagram showing the configuration of a computer system of a first embodiment of the present invention;

FIG. 2 is a block diagram showing the configuration of a host computer of the first embodiment of the present invention;

FIG. 3 is a block diagram showing the configuration of a backup server of the first embodiment of the present invention;

FIG. 4 is a block diagram showing the configuration of a storage device of the first embodiment of the present invention;

FIG. 5 is a block diagram showing the configuration of a management computer of the first embodiment of the present invention;

FIG. 6 is an explanatory view of a storage management table of the first embodiment of the present invention;

FIG. 7 is an explanatory view of a volume management table of the first embodiment of the present invention;

FIG. 8 is an explanatory view of a copy pair management table of the first embodiment of the present invention;

FIG. 9 is an explanatory view of a snapshot management table of the first embodiment of the present invention;

FIG. 10 is a sequence chart showing local copy pair creation processing executed in the first embodiment of the present invention;

FIG. 11 is a sequence chart showing snapshot creation processing executed in the first embodiment of the present invention;

FIG. 12 is a block diagram showing the configuration of a computer system of a second embodiment of the present invention;

FIG. 13 is a block diagram showing the configuration of a storage device of the second embodiment of the present invention;

FIG. 14 is a sequence chart showing local copy pair creation processing executed in the second embodiment of the present invention;

FIG. 15 is a sequence chart showing snapshot creation processing executed in the second embodiment of the present invention; and

FIG. 16 is an explanatory view of a function of an alternate path program of the first embodiment of the present invention.

### DESCRIPTION OF THE PREFERRED EMBODIMENT

First of all, a first embodiment of the present invention is explained in detail in conjunction with the drawings.

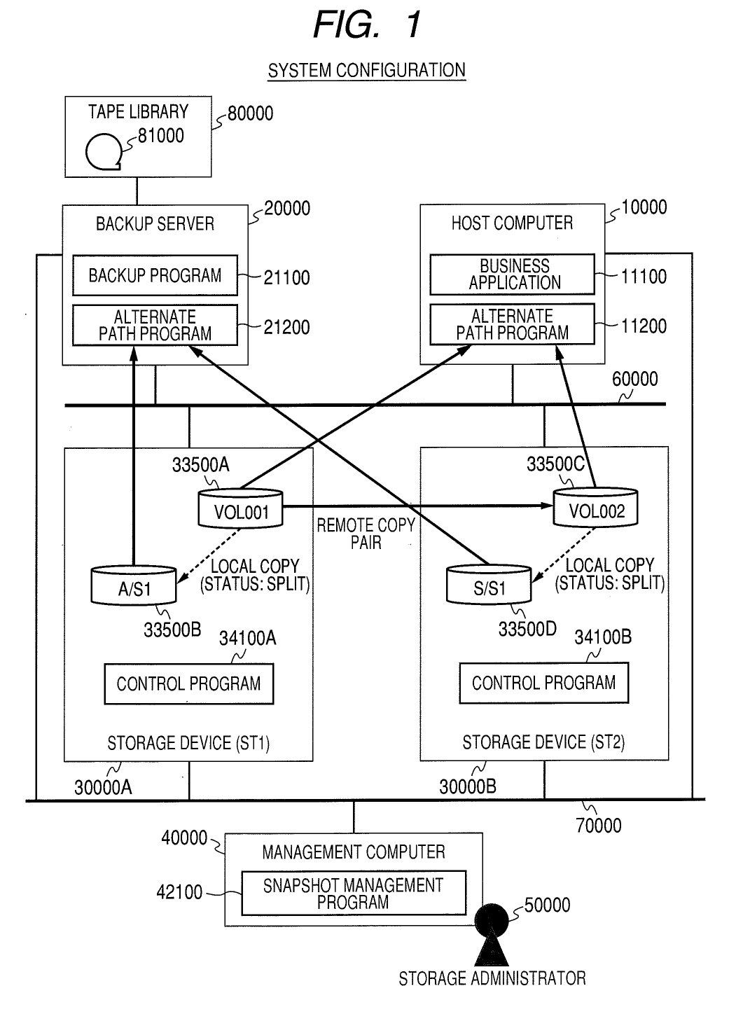

FIG. 1 is a block diagram showing the configuration of a computer system of the first embodiment according to the present invention.

The computer system of this embodiment includes a host computer 10000, a backup server 20000, a storage device 30000A, a storage device 30000B, a management computer 40000 and a tape library 80000.

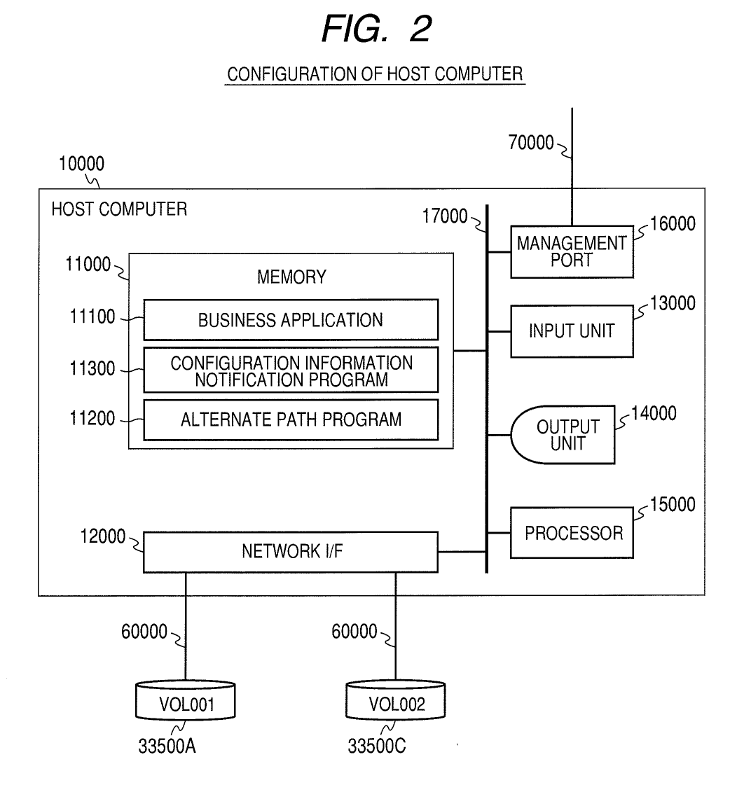

In the host computer 10000, at least a business application 11100 and an alternate path program 11200 are operated. The detailed configuration of the host computer 10000 is described later (see FIG. 2).

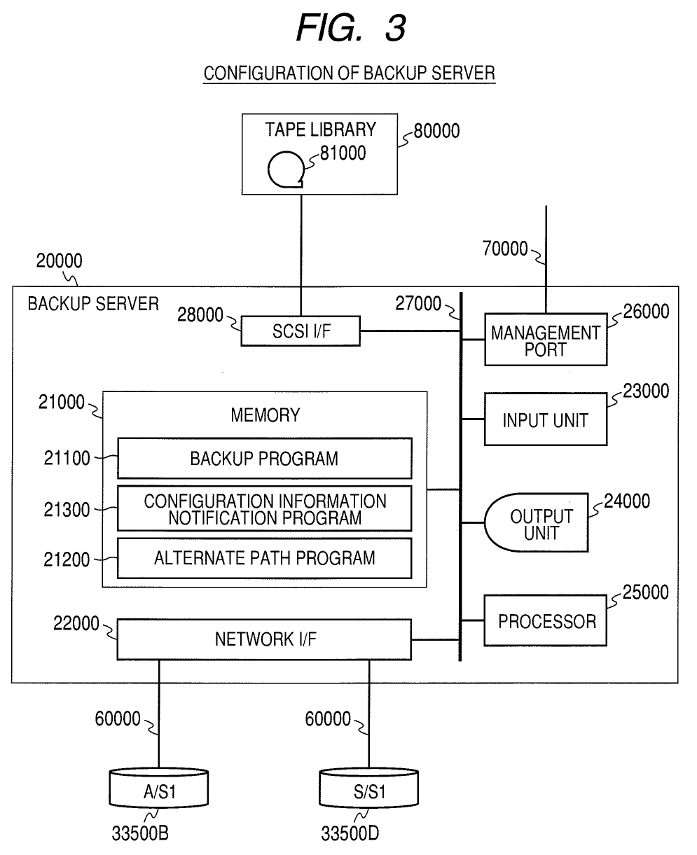

In the backup server 20000, at least a backup program 21100 and an alternate path program 21200 are operated. The detailed configuration of the backup server 20000 is described later (see FIG. 3).

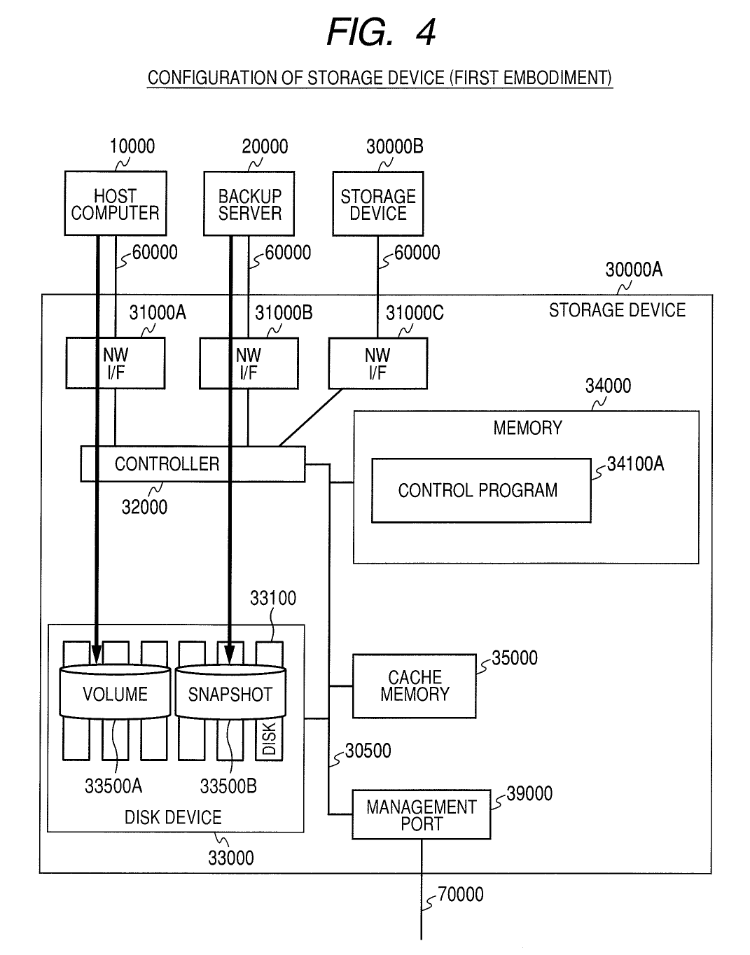

In the storage device 30000A, at least a control program 34100A is operated. Further, the storage device 30000A includes a logical volume 33500A and a logical volume 33500B. The logical volume 33500A and the logical volume 33500B are storage areas for storing data. The detailed configuration of the storage device 30000A is described later (see FIG. 4).

In the storage device 30000B, at least a control program 34100B is operated. Further, the storage device 30000B includes a logical volume 33500C and a logical volume 33500D. The logical volume 33500C and the logical volume 33500D are storage areas for storing data.

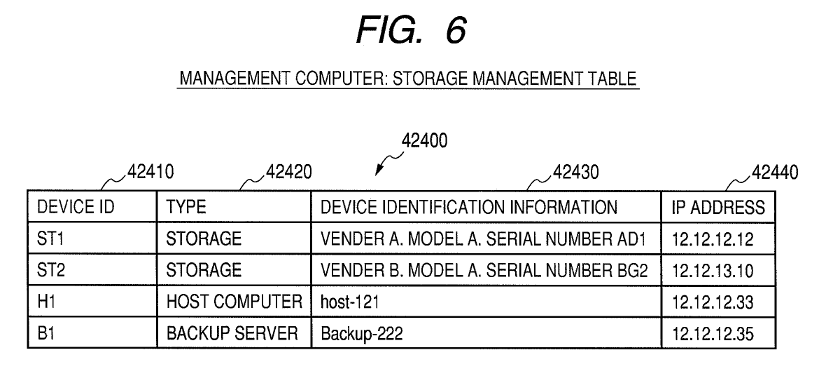

Here, in FIG. 1, “ST1” displayed on the storage device 30000A and “ST2” displayed on the storage device 30000B are identifiers respectively provided for identifying the storage device 30000A and the storage device 30000B. In the same manner, “VOL 001” displayed on the logical volume 33500A, “A/S1” displayed on the logical volume 33500B, “VOL 002” displayed on the logical volume 33500C and “S/S1” displayed on the logical volume 33500D are identifiers respectively provided for identifying the logical volume 33500A, the logical volume 33500B, the logical volume 33500C and the logical volume 33500D. These identifiers are referred to in a table described later (see FIG. 6 and the like).

In making the explanation which is applicable to both of the storage device 30000 and the storage device 30000B hereinafter, these storage devices may also be collectively referred to as the storage device 30000 in such explanation. In the same manner, the logical volumes 33500A to 33500D may also collectively referred to as a logical volume 33500. The control program 34100A and the control program 34100B may also be collectively referred to as a control program 34100.

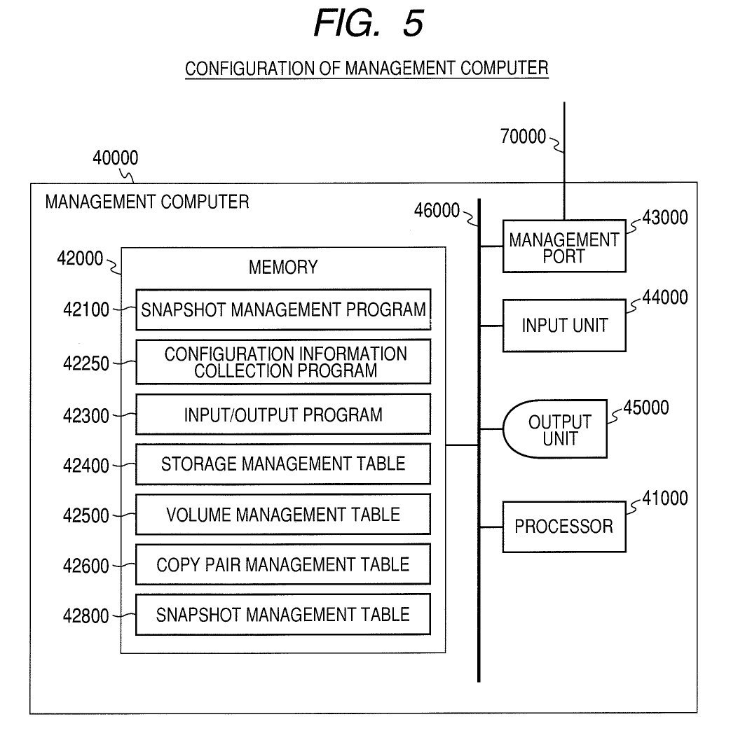

In the management computer 40000, at least a snapshot management program 42100 is operated. A storage administrator 50000 manages the computer system shown in FIG. 1 using the management computer 40000. The detailed configuration of the management computer 40000 is described later (see FIG. 5).

The tape library 80000 includes at least one magnetic tape memory medium 81000. The tape library 80000 is connected to the backup server 20000 and stores data transmitted from the backup server 20000 in the magnetic tape memory medium 81000. Here, the tape library 80000 may include other kind of memory medium (such as a magnetic disk memory medium, an optical disk memory medium or a semiconductor memory, for example) in place of the magnetic tape memory medium 81000.

The host computer 10000, the backup server 20000, the storage device 30000A and the storage device 30000B are connected with each other via a network 60000. The host computer 10000 and the backup server 20000 execute writing of data to the logical volume 33500 and reading of data from the logical volume 33500 via the network 60000.

The network 60000 may be any kind of network. For example, the network 60000 may be a network to which a Fibre Channel (FC) protocol is applied.

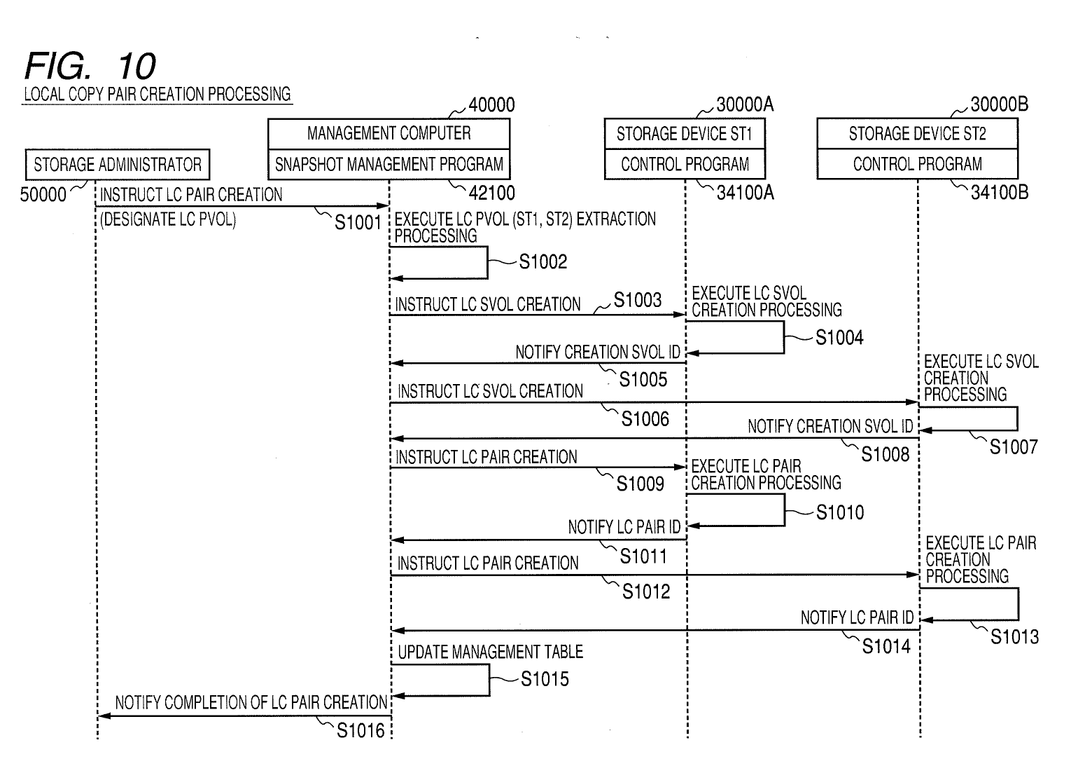

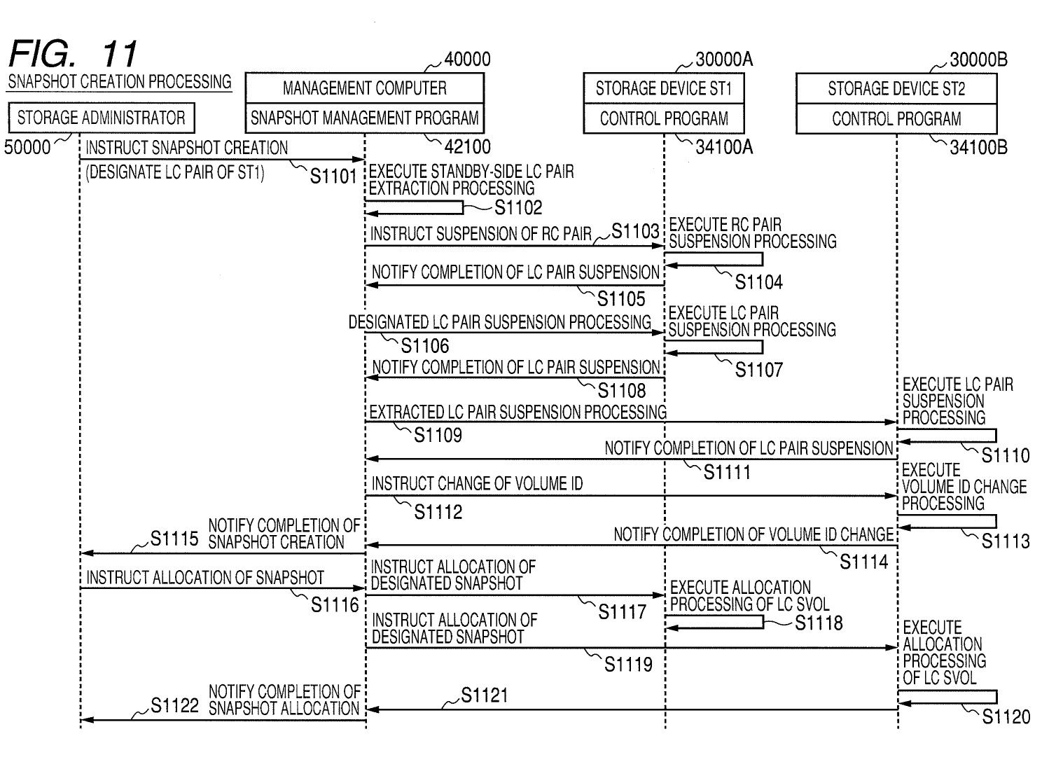

Further, the host computer 10000, the backup server 20000, the storage device 30000A, the storage device 30000B and the management computer 40000 are connected with each other via a network 70000. The management computer 40000 transmits instructions and information among the host computer 10000, the backup server 20000, the storage device 30000A and the storage device 30000B for performing management via the network 70000. For example, the instructions and notifications shown in FIG. 10 and FIG. 11 described later are transmitted and received via the network 70000.

The network 70000 may be any kind of network. For example, the network 70000 may be a network to which an internet protocol (IP) is applied.

Here, the relationship among four logical volumes 33500 and the relationship among the logical volumes 33500, the host computer 10000 and the backup server 20000 are explained in conjunction with FIG. 1.

The business application 11100 of the host computer 10000 realizes various kinds of applications which are used by a user of the host computer (for example, a data base or the like). The business application 11100 executes an access to a data I/O (that is, writing or reading of data) with respect to the logical volume 33500A or the logical volume 33500C when necessary.

The access destination is switched by an alternate path program 11200. Usually (that is, both storage devices 30000A and 30000B being operated normally), the access destination of the business application 11100 is the logical volume 33500A.

The logical volume 33500A and the logical volume 33500C form a copy pair by a so-called remote copy. In other words, in an example shown in FIG. 1, the logical volume 33500A stores data written by the host computer 10000 therein, and the logical volume 33500C stores a copy of the data stored in the logical volume 33500A therein.

In the explanation made hereinafter, a copy pair in which the above-mentioned remote copy is executed is also referred to as a remote copy pair.

Upon reception of a data write request from the host computer 10000 to the logical volume 33500A, the control program 34100A of the storage device 30000A stores the data in the logical volume 33500A in accordance with the request. Further, the control program 34100A transmits a data copy write request which requests writing of a copy of data which is requested to be written in the logical volume 33500C to the storage device 30000B via the network 60000. The control program 34100B of the storage device 30000B stores the data in the logical volume 33500C in accordance with the received request.

The logical volume 33500A further creates a copy pair with the logical volume 33500B using a so-called local copy. Upon reception of a data write request from the host computer 10000 to the logical volume 33500A, the control program 34100A further stores the copy of the data in the logical volume 33500B.

In the explanation made hereinafter, a copy pair in which an above-mentioned local copy is executed is also referred to as a local copy pair.

In the same manner, the logical volume 33500C further creates a copy pair with the logical volume 33500D using a so-called local copy. Upon reception of a data write request from the storage device 30000A to the logical volume 33500C, the control program 34100B further stores the copy of the data in the logical volume 33500D.

In respective copy pairs, the logical volume which constitutes a copy source of data is also referred to as a primary volume (PVOL) and the logical volume which constitutes a copy destination is also referred to as a secondary volume (SVOL). In the remote copy pair constituted of the logical volume 33500A and the logical volume 33500C, the logical volume 33500A constitutes the PVOL and the logical volume 33500C constitutes the SVOL. In the remote copy pair constituted of the logical volume 33500A and the logical volume 33500B, the logical volume 33500A constitutes the PVOL and the logical volume 33500B constitutes the SVOL. In the local copy pair constituted of the logical volume 33500C and the logical volume 33500D, the logical volume 33500C constitutes the PVOL and the logical volume 33500D constitutes the SVOL.

The control program 34100 can control a status of each copy pair. To be more specific, the control program 34100 can switch the status of each copy pair from “PAIR” to “SPLIT” or from “SPLIT” to “PAIR”.

When the copy pair is in the status of “PAIR”, a copy of data stored in the PVOL is also stored in the SVOL. On the other hand, when the copy pair is in the status of “SPLIT”, even when the data is stored in the PVOL of the copy pair, the copy of the data is not stored in the SVOL.

When all copy pairs shown in FIG. 1 are in the status of “PAIR” as described above, writing of data from the host computer 10000 to the logical volume 33500A is reflected on all other logical volumes 33500B to 33500D and, as a result, the same data is stored in four logical volumes 33500.

Thereafter, for example, when the status of the local copy pair constituted of the logical volume 33500A and the logical volume 33500B is changed to “SPLIT”, data stored in the logical volume 33500A after such a change is not stored in the logical volume 33500B. In other words, this status implies that the logical volume 33500B saves a copy of the logical volume 33500A at a point of time that the status of the local copy pair is changed. The copy of data stored in the logical volume 33500 at a specific point of time is also referred to as a snapshot.

In the example shown in FIG. 1, the status of the local copy pair constituted of the logical volume 33500A and the logical volume 33500B is changed to “SPLIT” and, further, at the same timing of the change, the status of the local copy pair constituted of the logical volume 33500C and the logical volume 33500D is also changed to “SPLIT”. Since the timings of these changes are the same, the same data is stored in the logical volume 33500B and the logical volume 33500D. In other words, snapshots formed at the same point of time are stored in the logical volume 33500B and the logical volume 33500D.

Here, the sequence of change of the status of the respective copy pairs is explained later in conjunction with FIG. 11.

A backup program 21100 of the backup server 20000 reads the data of the snapshot and stores the data in the tape library 80000. To be more specific, the backup program 21100 sequentially reads the data stored in the logical volume 33500B or the logical volume 33500D and transmits the data to the tape library 80000.

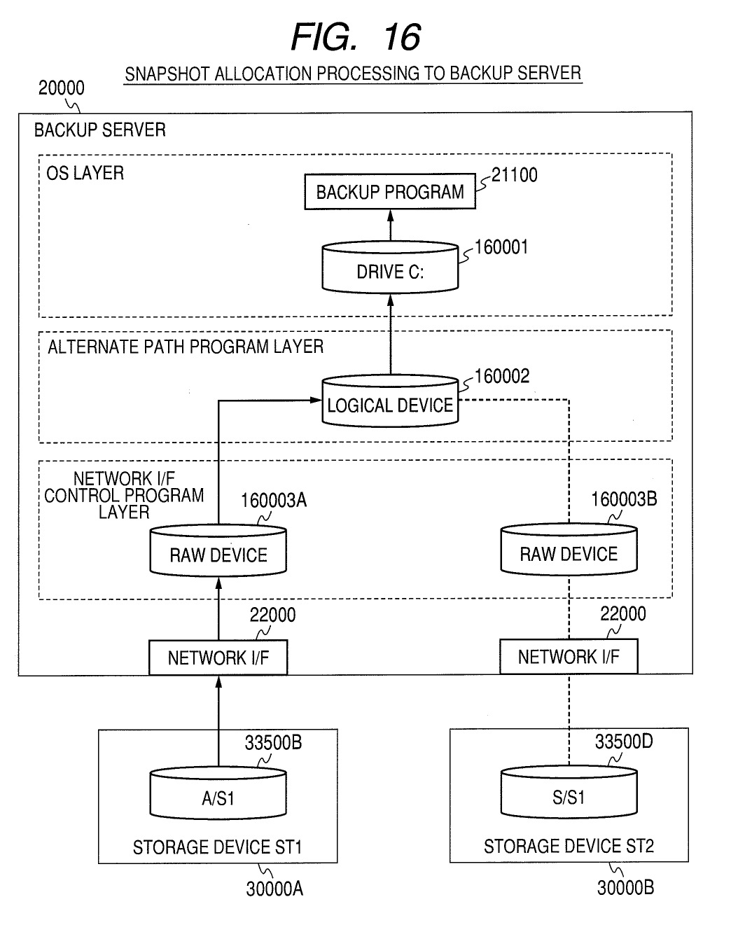

The alternate path program 21200 switches the access destinations based on the backup program 21100 in the same manner as the alternate path program 11200. The switching method is described later in conjunction with FIG. 16. Usually (that is, when both storage devices 30000A and 30000B are operated normally), the access destination of the backup program 21100 is the logical volume 33500B.

FIG. 2 is a block diagram showing the configuration of the host computer 10000 according to the first embodiment of the present invention.

The host computer 10000 includes a memory 11000, a network interface (I/F) 12000, an input unit 13000, an output unit 14000, a processor 15000 and a management port 16000. These respective constitutional parts are connected with each other via an internal bus 17000.

The memory 11000 is a semiconductor memory, for example, and stores the program to be executed by the processor 15000, the data to be referenced by the processor 15000 and the like. In this embodiment, in the memory 11000, the business application 11100, the alternate path program 11200 and a configuration information notification program 11300 are stored. All of them are programs executed by the processor 15000. Accordingly, in this embodiment, the processing executed using these programs are executed by the processor 15000 in an actual operation.

The business application 11100 is a program for realizing an application which the host computer 10000 provides to a user of the computer system.

The configuration information notification program 11300 notifies to the management computer 40000 of information indicative of the configuration of the host computer 10000 (for example, information indicating which logical volume is allocated to a C drive of the host computer 10000 and the like).

The alternate path program 11200 switches the path to be used by the business application 11100 to access the logical volume 33500. To be more specific, when there is a plurality of paths which leads one the logical volume 33500 from the host computer 10000, the alternate path program 11200 selects one of the plurality of paths as a path which allows the business application 11100 to access the logical volume 33500. When a failure is detected in the path, the alternate path program 11200 switches the access path to other normal path for access. The alternate path program 11200 implies an application operated on an OS or a network I/F control program on a network I/F.

In this embodiment, the storage device 30000B notifies the host computer 10000 of an identifier equal to an identifier of the logical volume 33500A as an identifier of the logical volume 33500C. Accordingly, the alternate path program 11200 recognizes the logical volume 33500A and the logical volume 33500C as one logical volume. That is, the alternate path program 11200 recognizes the path leading to the logical volume 33500A and the path leading to the logical volume 33500C as two paths leading to one logical volume.

Here, although omitted from FIG. 2, an operating system (OS) is also stored in the memory. The business application 11100 and the configuration information notification program 11300 are operated on the OS.

An input unit 13000 is a device used by a user of the host computer 10000 to input desired information to the host computer 10000. For example, the input unit 13000 may include at least any one of a keyboard and a mouse. The input unit 13000 may also include any other input device.

An output unit 14000 is a device which the host computer 10000 uses for providing information to a user of the host computer 10000. For example, although the output unit 14000 may be an image display device, the output unit 14000 may be any other output device.

The processor 15000 is a central processing unit for executing the program stored in the memory 11000.

The network I/F 12000 is an interface which is connected to the network 60000 and executes communication between the host computer 10000 and the storage device 30000 (access to the logical volume 33500A or 33500C in this embodiment) via the network 60000. The network I/F 12000 may be a host bus adapter for executing communication based on an FC protocol, for example.

The management port 16000 is an interface which is connected to a network 70000 and executes communication between the host computer 10000 and the management computer 40000 via the network 70000.

FIG. 3 is a block diagram showing the configuration of the backup server 20000 of the first embodiment of the present invention.

The backup server 20000 is a computer which includes a memory 21000, a network I/F 22000, an input unit 23000, an output unit 24000, a processor 25000, a management port 26000 and an SCSI_I/F 28000. These respective constitutional parts are connected with each other via an internal bus 27000.

The memory 21000 is a semiconductor memory, for example, and stores a program to be executed by the processor 25000, data to be referenced by the processor 25000 and the like. In this embodiment, in the memory 11000, the backup program 21100, the alternate path program 21200 and the configuration information notification program 21300 are stored. All of them are programs executed by the processor 25000. Accordingly, in this embodiment, the processing executed using these programs are executed by the processor 25000 in an actual operation.

The backup program 21100 is a program for realizing a backup function which the backup server 20000 provides. To be more specific, the backup program 21100 reads data from the logical volume 33500 (from the logical volume 33500B or 33500D in the example shown in FIG. 1) and controls the storing of the read data in the magnetic tape memory medium 81000.

The configuration information notification program 21300 notifies the management computer 40000 of information indicative of the configuration of the backup server 20000 (for example, information indicating which logical volume is allocated to a C drive of the backup computer 20000 and the like).

The alternate path program 21200 is a program for realizing the same function as the alternate path program 11200 and switches the currently used path to a path used for getting access to the logical volume 33500 based on the backup program 21100.

In this embodiment, the storage device 30000B notifies the backup server 20000 of the identifier equal to the identifier of the logical volume 33500B as an identifier of the logical volume 33500D. Accordingly, the alternate path program 21200 recognizes the logical volume 33500B and the logical volume 33500D as one logical volume. That is, the alternate path program 21200 recognizes the path leading to the logical volume 33500B and the path leading to the logical volume 33500D as two paths leading to one logical volume.

Here, although omitted from FIG. 3, an OS is also stored in the memory. The backup program 21100 and the configuration information notification program 21300 are operated on the OS.

The input unit 23000 is a device provided for allowing a user of the backup server 20000 to input desired information to the backup server 20000. For example, the input unit 23000 may be configured in the same manner as the input unit 13000.

The output unit 24000 is a device provided for allowing the backup server 20000 to provide the information to the user of the backup server 20000. For example, the output unit 24000 may be configured in the same manner as the output unit 14000.

The processor 25000 is a central processing unit for executing a program stored in the memory 21000.

The network I/F 22000 is an interface which is connected to the network 60000 and executes communication between the backup server 20000 and the storage device 30000 (access to the logical volume 33500B or access to 33500C in this embodiment) via the network 60000. The network I/F 12000 may be a host bus adapter for executing communication based on an FC protocol, for example.

The management port 26000 is an interface connected to a network 70000 and executes communication between the backup server 20000 and the management computer 40000 via the network 70000.

The SCSI_I/F 28000 is an interface which is connected to the tape library 80000 and executes communication between the backup server 20000 and the tape library 80000.

Here, the function of the alternate path program 21200 is explained.

FIG. 16 is an explanatory view of the function of the alternate path program 21200 of the first embodiment of the present invention.

For explaining the function of the alternate path program 21200, the allocation processing of the logical volume which stores the snapshot (that is, the logical volumes 33500B and 33500D) to the backup server 20000 is explained in conjunction with FIG. 16.

As described later in detail, identifiers which are univocal in the whole world are given to the logical volumes 33500B and 33500D. The alternate path program 21200 on the backup server 20000 makes an inquiry at predetermined timing (for example, periodically) to the respective storage devices 30000 with respect to the identifiers of the logical volume 33500 which is held by the storage device 30000. The storage device 30000B which receives this inquiry, when the storage device 30000B holds the logical volume 33500D allocated to the backup server 20000, usually responds to the backup server 20000 with the identifier which univocally identifies the logical volume 33500D in the whole world. The inquiry and the response are realized based on the Inquiry of an SCSI, for example. In the following explanation, the inquiry is referred to as the configuration information notification request.

However, the storage device 30000B of this embodiment, when the identifier of the logical volume 33500D is changed to an identifier equal to the identifier of the logical volume 33500B as described later, responds to the backup server 20000 with the identifier of the logical volume 33500B in place of the identifier of the logical volume 33500D in response to the configuration information notification request from the backup server 20000.

Raw devices 160003A and 160003B are logical devices which the network I/F control program (that is, the driver which controls the network I/F 12000) holds. In other words, the raw devices 160003A and 160003B are logical devices which the network I/F 22000 provides to the OS or the alternate path program 21200. The network I/F 22000 prepares, for every path connected to the network I/F 22000, the raw device corresponding to the path.

In the example shown in FIG. 16, to the network I/F 22000, two paths, that is, a path which leads to the logical volume 33500B and a path which leads to the logical volume 33500D are connected. Accordingly, the network I/F 22000 prepares two raw devices which correspond to the respective two paths, that is, the raw devices 160003A and 160003B.

As described above, the storage device 30000B responds with the identifier of the logical volume 33500B in place of the identifier of the logical volume 33500D and hence, the same number is given to the raw devices 160003A and 160003B.

The logical device 160002 is a logical storage device which the alternate path program 21200 provides to the OS of the backup server 20000.

A drive C 160001 is a logical storage device which the OS of the backup server 20000 provides to the backup program 21100. The drive C 160001 is made to correspond to the logical device 160002.

The alternate path program 21200 adopts the raw devices 160003A and 160003B which are prepared using the logical volumes 33500 which have the same identifier as control objects, and selects one of the control objects and provide the selected control object to the OS as the logical device 160002.

For example, in the alternate path program 21200, when the raw device 160003A is in a normal state, the logical device 160002 and the raw device 160003A may be made to correspond to each other. In this case, a data I/O which the backup program 21100 issues to the drive C 160001 is executed with respect to the logical volume 33500B via the raw device 160003A which is made to correspond to the logical device 160002.

Thereafter, when the raw device 160003A is not in a normal state, the alternate path program 21200 executes switching of the path. To be more specific, the alternate path program 21200 releases the correspondence between the logical device 160002 and the raw device 160003A, and the new correspondence is made between the logical device 160002 and the raw device 160003B.

The case that the raw device 160003A is not in a normal state may be, for example, a case in which a failure occurs in a portion of a path leading from the network I/F 22000 to the logical volume 33500B and hence, the network I/F 22000 cannot access the logical volume 33500B.

When the path is switched in this manner, the data I/O which the backup program 21100 issues to the drive C 160001 thereafter is executed with respect to the logical volume 33500D via the raw device 160003B which is made to correspond to the logical device 160002.

In this manner, the alternate path program 21200 can switch the path based on a state of the storage device 30000 or the like. Accordingly, the OS and the backup program 21100 on the OS can continue the access to the drive C 160001 without being conscious of the switching of the path.

Here, the alternate path program 11200 of the host computer 10000 also switches the path with respect to the logical volumes 33500A and 33500C by a function similar to the above-mentioned function.

For example, upon reception of the configuration information notification request from the host computer 10000, the storage device 30000B responds with the identifier of the logical volume 33500A in place of the identifier of the logical volume 33500C. Accordingly, the alternate path program 11200 recognizes the logical volume 33500C as the logical volume 33500A.

Thereafter, the alternate path program 11200 switches the path leading to the logical volume 33500A and the logical volume 33500 when necessary.

To be more specific, in the same manner as the case of the alternate path program 21200, the alternate path program 11200 executes, when the alternate path program 11200 can normally access the logical volume 33500A, the data I/O which the business application 11100 issues with respect to the logical volume 33500A. Further, when the alternate path program 11200 cannot normally access the logical volume 33500A due to a failure or the like, the alternate path program 11200 switches an object to which the alternate path program 11200 executes the data I/O issued by the business application 11100 from the logical volume 33500A to the logical volume 33500C.

FIG. 4 is a block diagram showing the configuration of the storage device 30000 of the first embodiment of the present invention.

In FIG. 4, the configuration of the storage device 30000A is shown as an example.

The storage device 30000A includes a network I/F 31000A, a network I/F 31000B, a network I/F 31000C, a controller 32000, a disk device 33000, a memory 34000, a cache memory 35000 and a management port 39000. The controller 32000, the disk device 33000, the memory 34000, the cache memory 35000 and the management port 39000 are connected with each other via an internal bus 30500.

The network I/F 31000A is an interface which is connected to a network 60000 and executes communications between the storage device 30000A and a host computer 10000 via the network 60000. The network I/F 31000B is an interface which is connected to the network 60000 and executes communications between the storage device 30000A and a backup server 20000 via the network 60000. The network I/F 31000C is an interface which is connected to the network 60000 and executes communications between the storage device 30000A and a storage device 30000B via the network 60000. The network I/Fs 31000A to 31000C may be, for example, formed of a host bus adapter which executes communications using an FC protocol.

The controller 32000 is a control device which controls the storage device 30000A. The controller 32000 may include a processor which executes a program stored in the memory 34000.

The memory 34000 is, for example, a semiconductor memory and stores the program to be executed by the controller 32000, and data which is referenced by the controller 32000 and the like. In this embodiment, a control program 34100A is stored in the memory 34000. The control program 34100A is a program to be executed by the controller 32000. Accordingly, in this embodiment, the processing executed using the control program 34100A is executed by the controller 32000 in an actual operation.

The disk device 33000 includes one or more disks 33100. Each disk 33100 is, for example, a hard disk drive (HDD). The disk device 33000 may include a plurality of disks 33100, and the plurality of disks 33100 may constitute a RAID (Redundant Arrays of Inexpensive Disks).

A storage area which one or more disks 33100 in the disk device 33000 have is provided to the host computer 10000 as one or more logical volumes 33500. In this embodiment, the logical volumes 33500A and 33500B receive I/O from the host computer 10000 and the backup server 20000 respectively. Each logical volume 33500 is treated as one storage device by an upper computer (that is, the host computer 10000 or the backup server 20000). One logical volume 33500 may include only the storage area of one disk 33100 or the storage areas of a plurality of disks 33100.

The cache memory 35000 is a semiconductor memory which is used for accelerating write and read processing with respect to the logical volume 33500. The cache memory 35000 temporarily stores data which is written into the logical volume 33500 and data which is read out from the logical volume 33500.

The management port 39000 is an interface which is connected to the network 70000 and executes communications between the storage device 30000A and a management computer 40000 via the network 70000.

The configuration of the storage device 30000B is similar to the configuration of the storage device 30000A. However, in the memory 34000 of the storage device 30000B, a control program 34100B which realizes a function similar to the function of the control program 34100A is stored. Further, in the disk device 33000 of the storage device 30000B, logical volumes 33500C and 33500D are prepared.

FIG. 5 is a block diagram showing the configuration of the management computer 40000 of the first embodiment of the present invention.

The management computer 40000 includes a processor 41000, a memory 42000, a management port 43000, an input unit 44000 and an output unit 45000. The respective constitutional parts are connected with each other via an internal bus 46000.

The memory 42000 is, for example, a semiconductor memory, and stores the program to be executed by the processor 41000, data to be referenced by the processor 41000 and the like. In this embodiment, a snapshot management program 42100, a configuration information collection program 42250 and an input/output program 42300 are stored in the memory 42000. All of them are programs executed by the processor 41000. Accordingly, in this embodiment, the processing executed using programs are executed by the processor 41000 in an actual operation.

The snapshot management program 42100 controls the creation of a snapshot or the like. As described later, the snapshot management program 42100 also issues instructions to change the identifier of the logical volume 33500.

The configuration information collection program 42250 collects configuration information from the host computer 10000, the backup server 20000 and the respective storage devices 30000. For example, the configuration information collection program 42250 collects the information which the configuration information notification program 11300 or the like notifies.

The input/output program 42300 controls inputting/outputting of the information executed by an input unit 44000 and an output unit 45000.

In the memory 42000, a device management table 42400, a volume management table 42500, a copy pair management table 42600 and a snapshot management table 42800 are further stored. These tables are described later (see FIG. 6 and the like).

The input unit 44000 is a device provided for allowing a storage administrator 50000 to input desired information to the management computer 40000. For example, the input unit 44000 may be configured in the same manner as the input unit 13000.

The output unit 45000 is a device provided for allowing the management computer 40000 to provide the information to the storage administrator 50000. For example, the output unit 45000 may be configured in the same manner as the output unit 14000.

The processor 41000 is a central processing unit which executes a program stored in the memory 42000.

The management port 43000 is an interface which is connected to the network 70000 and executes communication of the management computer 40000 with the host computer 10000, the backup server 20000 and the respective storage devices 30000 via the network 70000.

FIG. 6 is an explanatory view of the storage management table 42400 of the first embodiment of the present invention.

The device management table 42400 includes management information on the respective devices in the computer system.

To be more specific, the storage management table 42400 includes device IDs 42410, device type 42420, device identification information 42430 and IP addresses 42440.

The device ID 42410 is an identifier given to each device. The identifier is univocal at least in the computer system managed by the management computer 40000.

The device type 42420 is information indicative of a type of each device (information on whether the device is a computer or a storage device, for example). The information may further contain information indicative of the application of the computer (information on whether the computer is the host computer or the backup server, for example).

The device identification information 42430 is information which univocally identifies each device. The device identification information 42430 may contain a vendor name, a model name and a serial number of the device, for example. Accordingly, each device can be univocally identified in the whole world.

The IP address 42440 is an IP address of a management port of each device. The management computer 40000 uses the IP address as a destination address for communication in communicating with each device.

In the example shown in FIG. 6, a head entry of the device management table 42400 is management information on the storage device 30000A. As the device ID 42410, the device type 42420, the device identification information 42430 and the IP address 42440 of the entry, “ST1”, “Storage”, “Vendor A, Model A, Serial Number AD1” and “12.12.12.12” are registered respectively. This entry implies that a device which is identified by the identifier “ST1” (that is, storage device 30000A) is a storage device, the vendor name, the model name and the serial number of the storage device 30000A is “A”, “A” and “AD1” respectively, and the IP address of the management port 39000 of the storage device 30000A is “12. 12. 12. 12”. The information may be inputted by the storage administrator 50000.

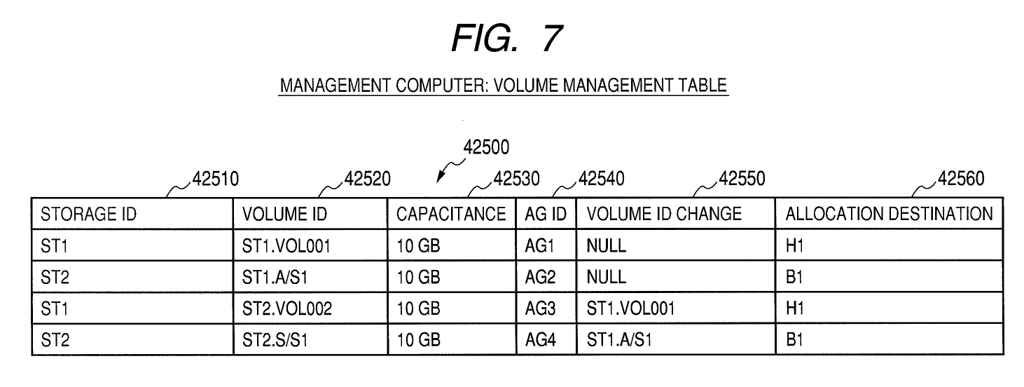

FIG. 7 is an explanatory view of a volume management table 42500 of the first embodiment of the present invention.

The volume management table 42500 includes management information on the logical volume 33500 included in each storage device 30000.

To be more specific, the volume management table 42500 includes storage IDs 42510, volume IDs 42520, capacities 42530, AGIDs 42540, volume ID changes 42550 and allocation destinations 42560.

The storage IDs 42510 are identifiers of the storage devices 30000 which include the respective logical volumes 33500.

The volume IDs 42520 are identifiers of the respective logical volumes 33500. The volume IDs 42520 contain an identifier of the storage device 30000 which includes the respective logical volumes 33500 and identifiers which the respective storage devices 30000 give to the respective logical volumes 33500 and are univocal in the respective storage devices 30000. By combining these identifiers, the respective logical volumes 33500 can be identified univocally at least in the computer system managed by the management computer 40000.

The capacity 42530 is a data storage capacity of each logical volume 33500.

The AGIDs 42540 are identifiers of array groups (AG) to which the respective logical volumes 33500 belong. That is, the AGIDs 42540 are identifiers of array groups which include physical storage areas corresponding to the respective logical volumes 33500.

An array group is a group constituting a unit for data management based on a function of a RAID, when the RAID is constituted of a plurality of disks 33100. For example, when a RAID level 5 of a so-called 3D (data)+1P (parity) is applied, four disks 33100 constitutes one array group.

The volume ID change 42550 is an identifier indicative of the change of each logical volume 33500. When the identifier is not changed, “NULL” is registered as the volume ID change 42550.

The allocation destinations 42560 are identifiers of a computer to which the respective logical volumes 33500 are allocated.

In the example shown in FIG. 7, a head entry of the volume management table 42500 is management information on the logical volume 33500A shown in FIG. 1. “ST1”, “ST1. VOL 001”, “10 GB”, “AG1”, “NULL” and “H1” are respectively registered as the storage ID 42510, the volume ID 42520, the capacity 42530, the AGID 42540, the volume ID change 42550 and the allocation destination 42560 of the entry. This implies that the logical volume 33500 to which the identifier “VOL001” is given by the storage device 30000 (that is, the storage device 30000A) identified by the “ST1” (that is, the logical volume 33500A) is univocally identified by the “ST1. VOL001” in the computer system, the logical volume 33500A has 10 gigabytes (GB) of storage capacity, a storage area corresponding to the logical volume 33500A belongs to an array group identified by the “AG1”, the identifier of the logical volume 33500A is not changed, and the logical volume 33500A is allocated to the computer identified by the “H1” (that is, the host computer 10000).

On the other hand, in the example shown in FIG. 7, an end entry of the volume management table 42500 is management information on the logical volume 33500D shown in FIG. 1. “ST2”, “ST2. S/S1”, “10 GB”, “AG4”, “ST1. A/S1” and “B1” are respectively registered as the storage ID 42510, the volume ID 42520, the capacity 42530, the AGID 42540, the volume ID change 42550 and the allocated destination 42560 of the entry. This implies that the logical volume 33500 to which the identifier “S/S1” is given (that is, the logical volume 33500D) by the storage device 30000 identified by the “ST2” (that is, the storage device 30000B) is univocally identified by the “ST2. S/S1” in the computer system, the logical volume 33500D has storage capacity of 10 gigabytes (GB), a storage area corresponding to the logical volume 33500D belongs to an array group identified by the “AG4”, the identifier of the logical volume 33500A is changed to “ST1. A/S1” (that is, an identifier equal to the identifier of the logical volume 33500B shown in FIG. 1), and the logical volume 33500D is allocated to the computer identified by the “B1” (that is, the backup server 20000).

When the identifier is changed as in the case of the above-mentioned logical volume 33500D, upon reception of a configuration information notification request from the backup server 20000, the storage device 32000B responds with the identifier “ST1. A/S1” in place of the original identifier “ST2. S/S1” of the logical volume 33500D.

Here, in this embodiment, when it is necessary to univocally identify the respective logical volumes 33500 in the computer system, a value including the identifier of the storage device 30000 (for example, a value such as “ST1. VOL001”) is used as the identifier of each logical volume 33500.

Alternatively, as the identifier of the storage device 30000, without using a value such as “ST1” which is univocal in the computer system, a value of device identification information 42430 (that is, a value including a vender name, a model name and a serial number of the device) may be used. With the use of such an identifier, the storage device 30000 is identified univocally in the whole world. Accordingly, provided that the value is included in the identifier of the logical volume 33500, each logical volume 33500 can be univocally identified in the whole world.

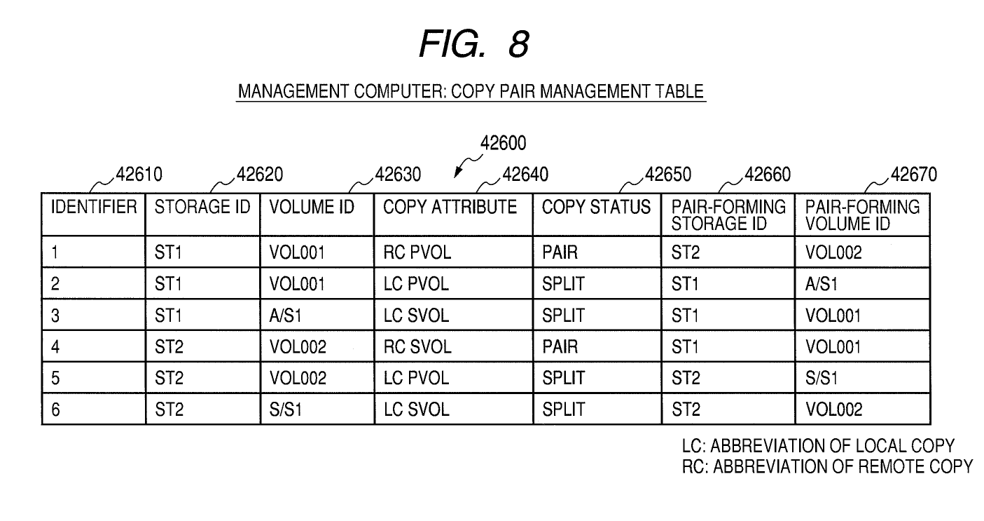

FIG. 8 is an explanatory view of a copy pair management table 42600 of the first embodiment of the present invention.

The copy pair management table 42600 includes management information on the copy pair existing in the computer system.

To be more specific, the copy pair management table 42600 includes an identifier 42610, a storage ID 42620, a volume ID 42630, a copy attribute 42640, a copy status 42650, a pair-forming storage ID 42660 and a pair-forming volume ID 42670.

The identifier 42610 is an identifier given to identify each copy pair.

The storage ID 42620, the volume ID 42630 and the copy attribute 42640 are information relating to one of two logical volumes 33500 constituting each copy pair. That is, the storage ID 42620 is the identifier of the storage device 30000 which includes the logical volume 33500, the logical volume 42630 is the identifier of the logical volume 33500, the copy attribute 42640 is the information indicative of whether the logical volume 33500 is a PVOL or a SVOL and whether the copy pair is a remote copy (RC) pair or a local copy (LC) pair.

The copy status 42650 is information indicative of the status of each copy pair.

The pair-forming storage ID 42660 and the pair-forming volume ID 42670 are information relating to the logical volume 33500 which creates a pair (that is, a copy pair) with a logical volume 33500 identified by the storage ID 42620 and the volume ID 42630 out of two logical volumes 33500 constituting each copy pair. That is, the pair-forming storage ID 42660 is an identifier of the storage device 30000 which includes the logical volume 33500 forming a pair with the logical volume 33500 identified by the storage ID 42620 and the volume ID 42630, and the pair-forming volume ID 42670 is the identifier of the logical volume 33500.

In the example shown in FIG. 8, the head entry of the copy pair management table 42600 is management information on the copy pair consisting of the logical volume 33500A and the logical volume 33500C shown in FIG. 1. “1”, “ST1”, “VOL001”, “RC PVOL”, “PAIR”, “ST2” and “VOL002” are respectively registered as the identifier 42610, the storage ID 42620, the volume ID 42630, the copy attribute 42640, the copy status 42650, the pair-forming storage ID 42660 and the pair-forming volume ID 42670 of the entry. This implies that the identifier “1” is given to the copy pair consisting of the logical volume 33500A identified by the “VOL 001” of the storage device 30000A which is identified by the “ST1” and the logical volume 33500C identified by the “VOL 002” of the storage device 30000B which is identified by the “ST2”, the copy pair is a remote copy (RC) pair, the logical volume 33500A of the copy pair is the PVOL, and the copy pair is in the status of “PAIR”.

In the example shown in FIG. 8, the copy pair identified by the value “1” of the identifier 42610 is equal to the copy pair identified by the value “4” of the identifier 42610. In the same manner, the copy pair identified by “2” is equal to the copy pair identified by “3”, and the copy pair identified by “5” is equal to the pair identified by “6”. The copy pair management table has such a configuration which enables an easy retrieval of each copy pair in which copy pair is selected using either PVOL or SVOL of the copy pair as a key.

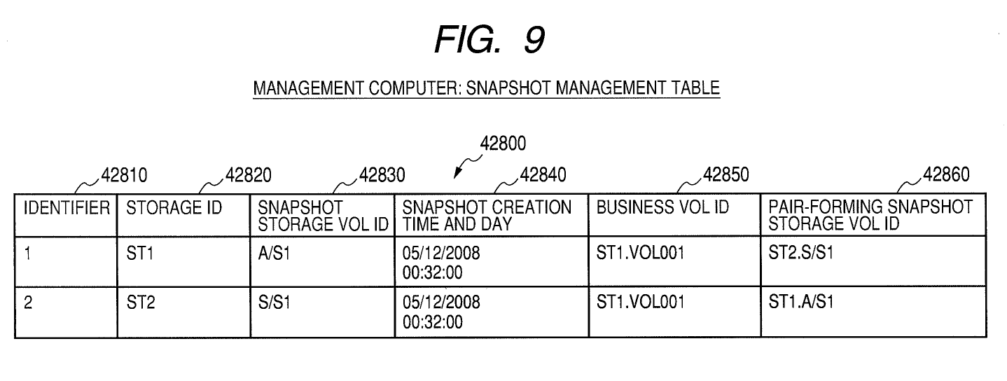

FIG. 9 is an explanatory view of a snapshot management table 42800 of the first embodiment of the present invention.

The snapshot management table 42800 includes management information on the snapshot which is provided in the computer system. To be more specific, the snapshot management table 42800 includes an identifier 42810, a storage ID 42820, a snapshot storage VOL_ID 42830, a snapshot creation time and date 42840, a business VOL_ID 42850 and a pair-forming snapshot storage VOL_ID 42860.

The identifier 42810 is information which identifies each snapshot.

The storage ID 42820 is an identifier of the storage device 30000 including the logical volume 33500 which stores each snapshot therein.

The snapshot storage VOL_ID 42830 is an identifier of the logical volume 33500 which stores each snapshot.

The snapshot creation time and date 42840 is information showing time and date at which each snapshot is created. To be more specific, for example, the snapshot creation time and date 42840 may be a time when a status of the copy pair between the logical volume 33500 which stores each snapshot and the logical volume 33500 which is a copy source of the snapshot is changed from “PAIR” to “SPLIT”.

The business VOL_ID 42850 is an identifier of the logical volume 33500 which is a copy source of each snapshot. However, as the identifier of the logical volume 33500, when a changed identifier (that is, the identifier registered as the volume ID change 42550) is notified to the host computer 10000 instead of the original identifier, the changed identifier is registered as the business VOL_ID 42850.

The pair-forming snapshot storage VOL_ID 42860 is an identifier of the logical volume 33500 which stores a snapshot having content identical with content of each snapshot.

In the example shown in FIG. 9, in an end entry of the snapshot management table 42800, as the identifier 42810, the storage ID 42820, the snapshot storage VOL_ID 42830, the snapshot creation time and date 41840, the business VOL_ID 42850 and the pair-forming snapshot storage VOL_ID 42860, “2”, “ST2”, “S/S1”, “2008/05/12 00:32. 00”, “ST1. VOL 001” and “ST1. A/S1” are registered respectively.

This entry shows that the identifier “2” is given to a snapshot stored in the logical volume 33500 identified by “S/S1” of the storage device 30000B identified by “ST2”, the snapshot is created at May 12, 2008, 00:32.00, “ST1. VOL001” is notified to the host computer 10000 as an identifier of the logical volume 33500C which is a source of the snapshot, and a snapshot having data identical with the snapshot is stored in the logical volume 33500B identified by “ST1. A/S1”.

A pair of the snapshots indicated by the pair-forming snapshot storage VOL_ID 42860 and the snapshot storage VOL_ID 42830 has the same creation time and date since the content of stored data of the snapshot indicated by the pair-forming snapshot storage VOL_ID 42860 and the content of stored data of the snapshot indicated by the snapshot storage VOL_ID 42830 completely agree with each other.

FIG. 10 is a sequence chart showing local copy pair creation processing executed in the first embodiment of the present invention.

This processing is executed for creating the local copy pair (in the example shown in FIG. 1, the copy pair consisting of the logical volumes 33500A and 33500B, and the copy pair consisting of the logical volumes 33500C and 33500D).

First of all, the storage administrator 50000 inputs the local copy pair creation instruction to the management computer 40000 using an input unit 44000 (step S1001). At this point of time, the remote copy pair consisting of the logical volumes 33500A and 33500C is already created. However, it is assumed that the logical volumes 33500B and 33500D are not yet formed.

Hereinafter, as an example, local copy pair creation processing executed for creating two local copy pairs shown in FIG. 1 is explained. Accordingly, at a point of time that this processing is started, second and fourth entries of a volume management table 42500 shown in FIG. 7 are not yet formed. Further, second, third, fifth and sixth entries of a copy pair management table 42600 shown in FIG. 8 are not yet formed. Still further, a snapshot management table 42800 shown in FIG. 9 is not yet formed.

The instruction made in step S1001 includes the designation of the PVOL of the local copy pair to be created. For example, the storage administrator 50000 designates an identifier “ST1. VOL001” of the logical volume 33500A, and instructs to create the local copy pair including this logical volume 33500A.

The snapshot management program 42100 of the management computer 40000 which receives the instruction made in step S1001 executes local copy PVOL extraction processing (step S1002). To be more specific, the snapshot management program 42100 looks up the copy pair management table 42600, and determines whether or not the designated logical volume 33500 is a PVOL of the remote copy pair. In the above-mentioned example, a copy attribute 42640 corresponding to the designated logical volume 33500A is “RC PVOL” and hence, it is determined that the logical volume 33500A is the PVOL of the remote copy pair.

When the designated logical volume 33500A is a PVOL of the remote copy pair, it is necessary to create the local copy pair also with respect to the SVOL of the remote copy pair (see steps S1006 to S1008 and steps S1012 to S1014 described later).

Next, the snapshot management program 42100 instructs the storage device 30000A including the designated logical volume 33500A to create the SVOL of the local copy pair including the designated logical volume 33500A (step S1003). The control program 34100A of the storage device 30000A which receives this instruction forms the logical volume 33500B to be formed as the SVOL of the local copy pair (step S1004), and notifies the management computer 40000 of an identifier “A/S1” of the formed logical volume 33500B (step S1005).

Next, the snapshot management program 42100 instructs the formation of the SVOL of the local copy pair with respect to the SVOL of the remote copy pair corresponding to the designated logical volume 33500A (step S1006). In this example, the SVOL of the remote copy pair corresponding to the logical volume 33500A is the logical volume 33500C. Accordingly, the instruction made in step S1006 is transmitted to the storage device 30000B which includes the logical volume 33500C.

The control program 34100B of the storage device 30000B which receives the instruction made in step S1006 forms the logical volume 33500D to be formed as the SVOL of the local copy pair (step S1007), and notifies the management computer 40000 of the identifier “S/S1” of the formed logical volume 33500D (step S1008).

Next, the snapshot management program 42100 instructs the storage device 30000A to create the local copy pair (step S1009). The control program 34100A of the storage device 30000A which receives this instruction creates the local copy pair consisting of the designated logical volume 33500A and the logical volume 33500B (step S1010), and notifies the management computer 40000 of the identifiers of the created local copy pair (“2” and “3” in the example shown in FIG. 8) (step S1011).

When the local copy pair is created, the control program 34100A stores the copy of all data stored in the PVOL of the local copy pair (that is, in the logical volume 33500A) in the SVOL (that is, in the logical volume 33500B), and a status of the local copy pair assumes “PAIR”. Thereafter, as long as the status of the local copy pair is held in “PAIR”, by storing the copy of data newly stored in the PVOL also in the SVOL, it is possible to maintain the identity between data stored in the PVOL and data stored in the SVOL.

Next, the snapshot management program 42100 instructs the storage device 30000B to create the local copy pair (step S1012). The control program 34100B of the storage device 30000B which receives this instruction creates the local copy pair consisting of the logical volume 33500C and the logical volume 33500D (step S1013), and notifies the management computer 40000 of the identifiers of the created local copy pair (“5” and “6” in an example shown in FIG. 8) (step S1014).

After the local copy pair is created, the control program 34100B stores a copy of all data stored in the PVOL of the local copy pair (that is, in the logical volume 33500C) in the SVOL (that is, in the logical volume 33500D), and a status of the local copy pair assumes “PAIR”. Thereafter, as long as the status of the local copy pair is held in “PAIR”, by storing the copy of data newly stored in the PVOL also in the SVOL, it is possible to maintain the identity between data stored in the PVOL and data stored in the SVOL.

Here, in step S1002, when it is determined that the designated logical volume 33500A is not the PVOL of the remote copy pair, processing in steps S1006 to S1008 and processing in steps S1012 to S1014 are not executed.

Next, the snapshot management program 42100 updates a management table which the management computer 40000 holds (step S1015).

To be more specific, a volume management table 42500 is updated based on the information which is notified in steps S1005 and S1008. Items except for the volume ID change 42550 in FIG. 7 indicate values in the volume management table 42500 updated in step S1015. At this point of time, the identifier of the logical volume 33500D is not yet changed and hence, “NULL” is registered as the volume ID change 42550 corresponding to the logical volume 33500D.

Further, the copy pair management table 42600 is updated based on the information which is notified in steps S1011 and S1014. The items except for the copy status 42650 in FIG. 8 indicate values in the copy pair management table 42600 updated in step S1015. At this point of time, the status of the respective local copy pair assumes “PAIR” and hence, “PAIR” is registered as the copy status 42650 corresponding to each local copy pairs.

Further, the snapshot management table 42800 is updated based on the information which is notified in steps S1005, S1008, S1011, and S1014. The items except for the snapshot creation time and the date 42840 in FIG. 9 indicate values in the snapshot management table 42800 updated in step S1015. At this point of time, the snapshot is not yet created (that is, the status of the local copy pair is not yet changed to “SPLIT”) and hence, “NULL” is registered in the snapshot time and date 42840.

Based on the updated snapshot management table 42800, the SVOL of the local copy pair which is newly created and the SVOL of the local copy pair which is formed corresponding to the SVOL of the local copy pair (the logical volumes 33500B and 33500D in the above-mentioned example) are made to correspond to each other.

Next, a snapshot management program 42100 notifies the storage administrator 50000 of the completion of the creation of the local copy pair using an output unit 45000.

With the above-mentioned processing, the local copy pair creation processing is finished (S1016).

FIG. 11 is a sequence chart showing snapshot creation processing executed in the first embodiment of the present invention.

This processing is executed for creating the snapshot in the SVOL of the local copy pair. Hereinafter, as an example, the explanation is made with respect to in a case in which four logical volumes 33500 are formed as shown in FIG. 1, and processing is executed for creating the snapshot in the logical volumes 33500B and 33500D. At a point of time that this processing is started, both of a status of the local copy pair consisting of the logical volumes 33500A and 33500B and a status of the local copy pair consisting of the logical volumes 33500C and 33500D assume “PAIR”.

First of all, the storage administrator 50000 inputs the snapshot creation instruction to the management computer 40000 using the input unit 44000 (step S1101). This instruction contains the designation of the local copy pair which constitutes an object in which the snapshot is to be created. In the above-mentioned example, the local copy pair consisting of the logical volumes 33500A and 33500B is designated.

The snapshot management program 42100 of the management computer 40000 which receives the instruction made in step S1101 extracts the local copy pair on a standby side (that is, on a storage device 30000B side in the example shown in FIG. 1) corresponding to the designated local copy pair (step S1102). To be more specific, the snapshot management program 42100 retrieves the SVOL on the standby side corresponding to the SVOL of the designated local copy pair by looking up the snapshot management table 42800.

For example, as described above, when the local copy pair consisting of the logical volumes 33500A and 33500B is designated, an identifier “ST2. S/S1” corresponding to the identifier “ST1. A/S1” of the SVOL is acquired. In this case, a local copy pair including the logical volume 33500D which is identified based on the acquired identifier is extracted in step S1102.

Next, the snapshot management program 42100 instructs the storage device 30000A to suspend the remote copy pair (that is, the change of the pair status from “PAIR” to “SPLIT”) (step S1103). Here, the remote copy pair is a remote copy pair including the PVOL of the designated local copy pair.

For example, when the local copy pair consisting of the logical volumes 33500A and 33500B is designated as described above, the logical volume 33500A which constitutes the PVOL also constitutes the PVOL of the remote copy pair consisting of the logical volumes 33500A and 33500C. This status can be confirmed by retrieving the copy pair management table 42600 using the identifier of the logical volume 33500A as a key. In this case, in step S1103, the snapshot management program 42100 instructs the storage device 30000A to suspend the remote copy pair consisting of the logical volumes 33500A and 33500C.

The control program 34100A of the storage device 30000A which receives this instruction suspends the remote copy pair (step S1104). To be more specific, the control program 34100A changes the status of the remote copy pair consisting of the logical volumes 33500A and 33500C from “PAIR” to “SPLIT”. After the status is changed, until the status of the pair is changed to “PAIR” again, updating of the logical volume 33500A is not reflected on the logical volume 33500C. In other words, processing for storing the copy of data stored in the logical volume 33500A in the logical volume 33500C is suspended during the period from a point of time that the status of the pair is changed to “SPLIT” to a point of time that the pair status is changed to “PAIR” again.

Next, the control program 34100A notifies the management computer 40000 of the completion of the suspension of the remote copy pair (step S1105).

When the status of the remote copy pair is changed to “SPLIT” in steps S1103 to S1105 described above, the copy status 42650 of the copy pair management table 42600 corresponding to the remote copy pair is changed to “SPLIT”.

Further, the snapshot management program 42100 instructs the storage device 30000A to suspend the designated local copy pair (step S1106).

The control program 34100A of the storage device 30000A which receives this instruction suspends the designated local copy pair (step S1107). To be more specific, the control program 34100A changes the status of the local copy pair consisting of the logical volumes 33500A and 33500B from “PAIR” to “SPLIT”. After the status is changed, until the pair status is changed to “PAIR” again, updating of the logical volume 33500A is not reflected on the logical volume 33500B. Accordingly, the copy of the content of the logical volume 33500A at a point of time that the pair status is changed (that is, snapshot) is created in the logical volume 33500B.

The control program 34100A executes the suspension of the local copy pair (step S1107) and the suspension of the remote copy pair (step S1104) at the same timing. Here, “at the same timing” may be expressed as “at timing at which the copy of the same data is stored in two SVOLs”.

Here, processing for suspending two copy pairs at the same timing is explained by taking a case in which data A (not shown in the drawing) and data B (not shown in the drawing) are sequentially stored in the logical volume 33500A as an example.

When the status of the remote copy pair assumes “PAIR” at a point of time that data A is stored in the logical volume 33500A, the copy of data A is transmitted to the storage device 30000B, and is stored in the SVOL of the remote copy pair (that is, logical volume 33500C).

At this point of time, the status of the local copy pair also assumes “PAIR” and hence, the copy of data A is further stored in the SVOL of the local copy pair (that is, logical volume 33500B).

Thereafter, when the control program 34100A changes the status of the remote copy pair to “SPLIT” before data B is stored in the logical volume 33500A, although data B is stored in the logical volume 33500A, the copy of data B is not stored in the logical volume 33500C.

Further, the control program 34100A changes the status of the local copy pair to “SPLIT” before the copy of data B is stored in the logical volume 33500B. Accordingly, the control program 34100A does not store the copy of data B in the logical volume 33500B until the control program 34100A changes the status of the local copy pair to “PAIR” again.

In this manner, at the same timing, in other words, at timing at which the copy of the same data (data A in the above-mentioned example) is stored in two SVOLs, the remote copy pair and the local copy pair are suspended. Accordingly, at the time of the suspension, it is possible to ensure the identity between data stored in the SVOL of the remote copy pair and data stored in the SVOL of the local copy pair.

Next, the control program 34100A notifies the management computer 40000 of the completion of the suspension of the local copy pair (step S1108).

When the status of the local copy pair is changed to “SPLIT” in steps S1106 to S1108 described above, the copy status 42650 of the copy pair management table 42600 corresponding to the local copy pair is changed to “SPLIT”.

Next, the snapshot management program 42100 instructs the storage device 30000B to suspend the local copy pair extracted in step S1102 (step S1109).

The control program 34100B of the storage device 30000B which receives this instruction suspends the extracted local copy pair (step S1110). To be more specific, the control program 34100B changes a status of the local copy pair consisting of the logical volumes 33500C and 33500D from “PAIR” to “SPLIT”. After the status is changed, until the pair status is changed to “PAIR” again, updating of the logical volume 33500C is not reflected on the logical volume 33500D. Accordingly, the copy of the content of the logical volume 33500C at a point of time that the pair status is changed (that is, snapshot) is created in the logical volume 33500D.

Here, after the copy of all data stored in the logical volume 33500C is stored in the logical volume 33500D before the suspension of the remote copy pair, and before the remote copy pair is resumed, the control program 34100B executes the suspension of the local copy pair (step S1110). For example, as described above, when the copy of data A is stored in the logical volume 33500C and the copy of data B is not stored in the logical volume 33500C, the control program 34100B suspends the local copy pair after the control program 34100B stores the copy of data A in the logical volume 33500D. Accordingly, at a point of time that the control program 34100B suspends the local pair, it is possible to ensure the identity between data stored in the logical volume 33500C and data stored in the logical volume 33500D.

The execution of processing in steps S1104, S1107 and S1110 at the above-mentioned timing eventually implies that each copy pair is suspended at timing that the copy of the same data (for example, data A) is stored in the logical volumes 33500B and 33500D. Accordingly, the identity between the data stored in the logical volume 33500B and data stored in the logical volume 33500D can be guaranteed. Thereafter, as long as the status of the two local copy pairs assume “SPLIT”, the identity between the data stored in the logical volume 33500B and data stored in the logical volume 33500D is held.

Both of data stored in the logical volume 33500B and data stored in the logical volume 33500D are a copy of data of the logical volume 33500A at a point of time that the remote copy pair is suspended. That is, data stored in the logical volume 33500B and data stored in the logical volume 33500D are snapshots of the logical volume 33500A created at this point of time.

The identity of data of these snapshots is guaranteed by the above-mentioned processing and hence, time information indicative of a point of time that the remote copy pair is suspended (for example, May, 12, 2008, 00:32:00) is registered at the snapshot creation time and date 42840 corresponding to the logical volume 33500B and the logical volume 33500D (see FIG. 9).

Next, the control program 34100B notifies the management computer 40000 of the completion of the suspension of the local copy pair (step S1111).

When the status of the local copy pair is changed to “SPLIT” in steps S1109 to S1111, the copy status 42650 of the copy pair management table 42600 corresponding to the local copy pair is changed to “SPLIT”.

Here, as described above, after the same snapshot is created in the logical volumes 33500B and 33500D, the snapshot management program 42100 may instruct the storage device 30000A to resume the remote copy pair. The control program 34100A of the storage device 30000A which receives this instruction changes the status of the remote copy pair to “PAIR”. Here, the control program 34100A transmits data stored in the logical volume 33500A to the storage device 30000B after the previous-time status of the remote copy pair is changed to “SPLIT”. The transmitted data is stored in the logical volume 33500C. Accordingly, the identity between the data stored in the logical volume 33500A and data stored in the logical volume 33500C can be guaranteed again.

As described above, when the status of the remote copy pair is changed to “PAIR”, the copy status 42650 of the copy pair management table 42600 corresponding to the remote copy pair is changed to “PAIR”. FIG. 8 shows an example of the copy pair management table 42600 after such a change.

Next, the snapshot management program 42100 transmits the instruction for changing the identifier of the logical volume 33500D to the storage device 30000B (step S1112). To be more specific, the snapshot management program 42100 acquires the identifier “ST1. A/S1” of the logical volume 33500B corresponding to the logical volume 33500D by looking up the snapshot management table 42800, and instructs the storage device 30000B to change the identifier of the logical volume 33500D to “ST1. A/S1”.

The control program 34100B of the storage device 30000B which receives this instruction changes the identifier of the logical volume 33500D to “ST1. A/S1” (step S1113). After the identifier of the logical volume 33500D is changed, the control program 34100B succeedingly manages the logical volume 33500D using the original identifier “ST2. S/S1”. However, upon reception of the configuration information notification request from an upper computer (backup server 20000, for example) based on the control program 34100B, the control program 34100B responds with the changed identifier “ST1. A/S1” in place of the original identifier “ST2. S/S1” (in other words, as the identifier of the logical volume 33500D). To realize this response, the storage device 30000B may hold information which makes these identifiers correspond to each other (table substantially equal to the snapshot management table 42800, for example).

To be more accurate, the response with the changed identifier with respect to the configuration information notification request becomes possible after the completion of snapshot allocation processing (step S1120) described later.

Next, the control program 34100B notifies the management computer 40000 of the completion of the change of the identifier of the logical volume 33500D (step S1114).

When the identifier of the logical volume 33500D is changed in steps S1112 to S1114 described above to “ST1. A/S1”, “ST1. A/S1” is registered in the volume ID change 42550 of the volume management table 42500 corresponding to the logical volume 33500D (see FIG. 7).

Next, the snapshot management program 42100 notifies the storage administrator 50000 of the completion of creation of the snapshot (step S1115).

Next, storage administrator 50000 inputs the instruction for allocating the snapshot to the management computer 40000 (step S1116). This instruction contains information on designation of a type of the snapshot and a type of the computer to which such a snapshot is allocated. Hereinafter, the explanation is made by taking a case in which this instruction contains information on the designation that the snapshot stored in the logical volume 33500B is allocated to the backup server 20000 as an example.

The snapshot management program 42100 of the management computer 40000 which receives this instruction instructs the storage device 30000A to allocate the designated snapshot (step S1117).

The control program 34100A of the storage device 30000A which receives this instruction allocates the SVOL of the local copy which stores the designated snapshot therein (that is, logical volume 33500B) to the backup server 20000 (step S1118).

To be more specific, the control program 34100A sets the storage device 30000A such that the control program 34100A can respond to the data I/O from the backup server 20000 to the logical volume 33500B, and the configuration information notification request.

To be more specific, for example, the control program 34100A may newly hold information which makes a worldwide name (WWN) of a port of a network I/F 22000 of the backup server 20000 (not shown in the drawing) and the logical volume 33500B correspond to each other, and the control program 34100A may allow the access to the logical volume 33500B from the port having the WWN contained in the information.

Next, the snapshot management program 42100 instructs the storage device 30000B to allocate the snapshot having the same content as the designated snapshot (step S1119). The logical volume 33500D in which the snapshot having the same content as the designated snapshot (in other words, the copy of data stored in the same logical volume at the same time) is stored can be specified by looking up the snapshot management table 42800.

The control program 34100B of the storage device 30000B which receives this instruction allocates the SVOL of the local copy which stores the snapshot having the same content as the designated snapshot (that is, logical volume 33500D) to the backup server 20000 (step S1120).

To be more specific, the control program 34100B sets the storage device 30000B such that, in the same manner as step S1118, the control program 34100B can respond to the data I/O transmitted to the logical volume 33500D from the backup server 20000 and the configuration information notification request.

Due to the processing in step S1120, the storage device 30000B is allowed to make a response with the changed identifier of the logical volume 33500D to the configuration information notification request from the backup server 20000.

Next, the control program 34100B notifies the management computer 40000 of the completion of the allocation of the logical volume 33500D (step S1121).

Next, the snapshot management program 42100 notifies the storage administrator 50000 of the completion of the allocation of the snapshot (step S1122).

With the above-mentioned processing, the snapshot creation processing is finished.

In this manner, the snapshot having the same content is created in two logical volumes 33500B and 33500D of the two storage devices 30000A and 30000B and, further, the same value “ST1. A/S1” is transmitted to the backup server 20000 as the identifiers of the storage devices 30000A and 30000B. As a result, an alternate path program 21200 of the backup server 20000 recognizes two logical volumes 33500B and 33500D as a single logical volume 33500B, and recognizes paths which lead to the two logical volumes 33500B and 33500D as two paths which lead to the single logical volume 33500B.

Thereafter, the backup server 20000 executes the backup of the snapshot. To be more specific, the backup program 21100 of the backup server 20000 reads data of the snapshot via the path which is selected by an alternate path program 21200, and stores the read data in a magnetic tape memory medium 81000 of a tape library 80000.

For example, the alternate path program 21200 selects the path which leads to the logical volume 33500B. In this case, the backup program 21100 reads data of the snapshot from the logical volume 33500B.

After the reading of data from the logical volume 33500B is started, when a failure occurs in the storage device 30000A before the reading of all data of the snapshot is finished, the alternate path program 21200 switches a path to be used from a path which leads to the logical volume 33500B to a path which leads to the logical volume 33500D. Due to such switching, the read destination of the data is switched to the logical volume 33500D from the logical volume 33500B. This switching is executed using a method explained in conjunction with FIG. 16. The backup program 21100 continues to read data from the logical volume 33500D using the switched path.

The same data is stored in the logical volume 33500B and the logical volume 33500D, and these volumes are recognized as a single logical volume and hence, when the path is switched in the course of the above-mentioned reading of data, out of data stored in the logical volume 33500D, only data which is not yet read from the logical volume 33500B can be read. In other words, after the path is switched, it is unnecessary to read data stored in the logical volume 33500D from the head of data. Accordingly, even when a failure occurs in one storage device 30000 in the course of the backup processing, it is possible to continue backup processing without suspending the backup processing and without reading duplicated data.

Further, as described above, information indicative of the correspondence relationship between the logical volumes 33500B and 33500D in which the same snapshot is stored is held in the management computer 40000 and the storage device 30000, and the alternate path program 21200 automatically switches the path based on the correspondence relationship. Accordingly, a management cost for switching the path can be reduced and, at the same time, it is possible to prevent the occurrence of a miss caused by a human.

Next, a computer system of a second embodiment according to the present invention is explained in detail in conjunction with the drawings.

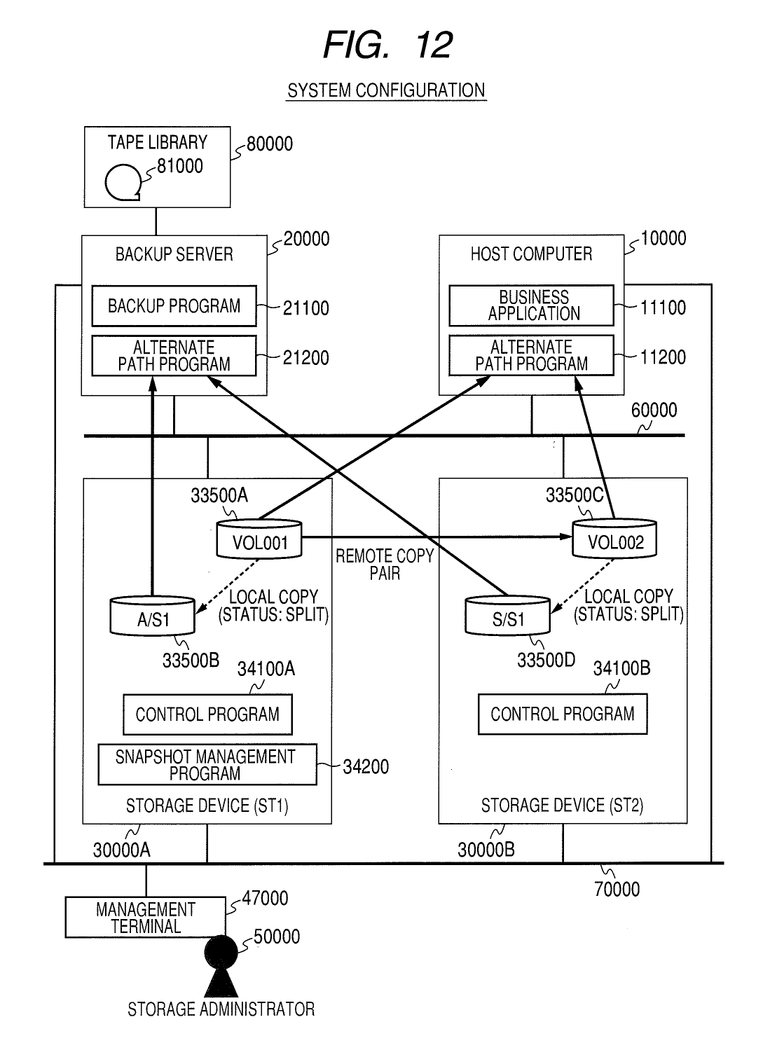

FIG. 12 is a block diagram showing the configuration of the computer system of the second embodiment according to the present invention.

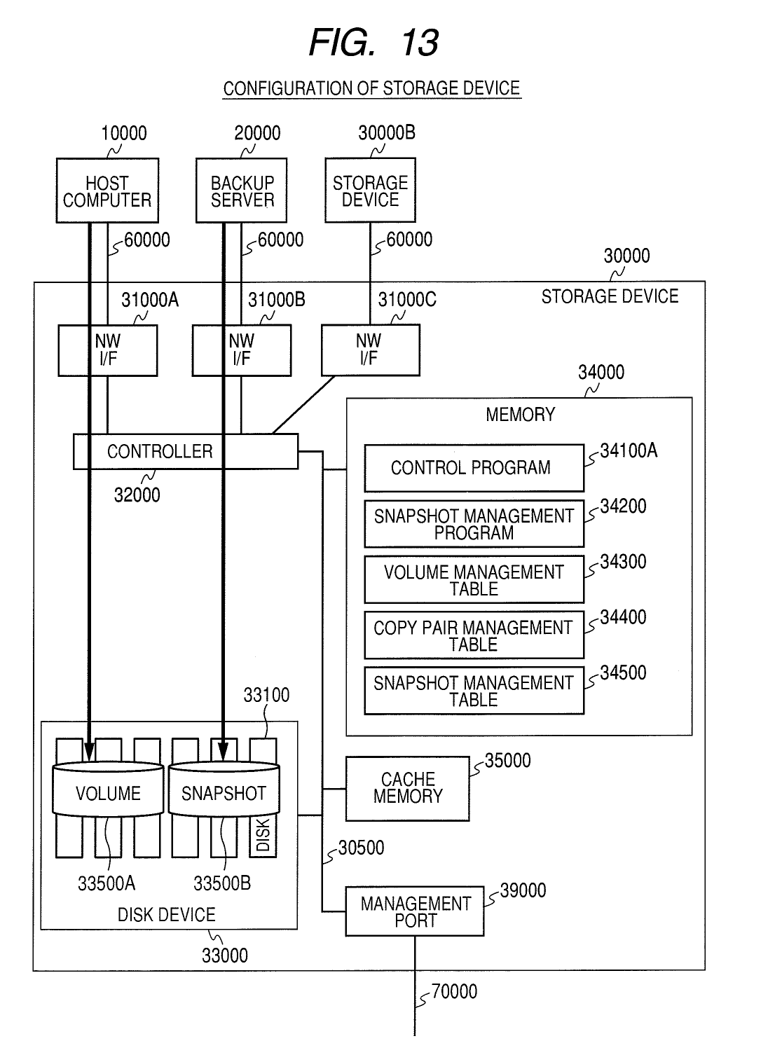

The computer system of this embodiment is substantially equal to the computer system of the first embodiment of the present invention except that the management computer 40000 is replaced with a management terminal 47000, and at least one storage device 30000 includes a snapshot management program 34200 and some tables (see FIG. 13). The computer system of the second embodiment is substantially equal to the computer system of the first embodiment except for the differences explained hereinafter.

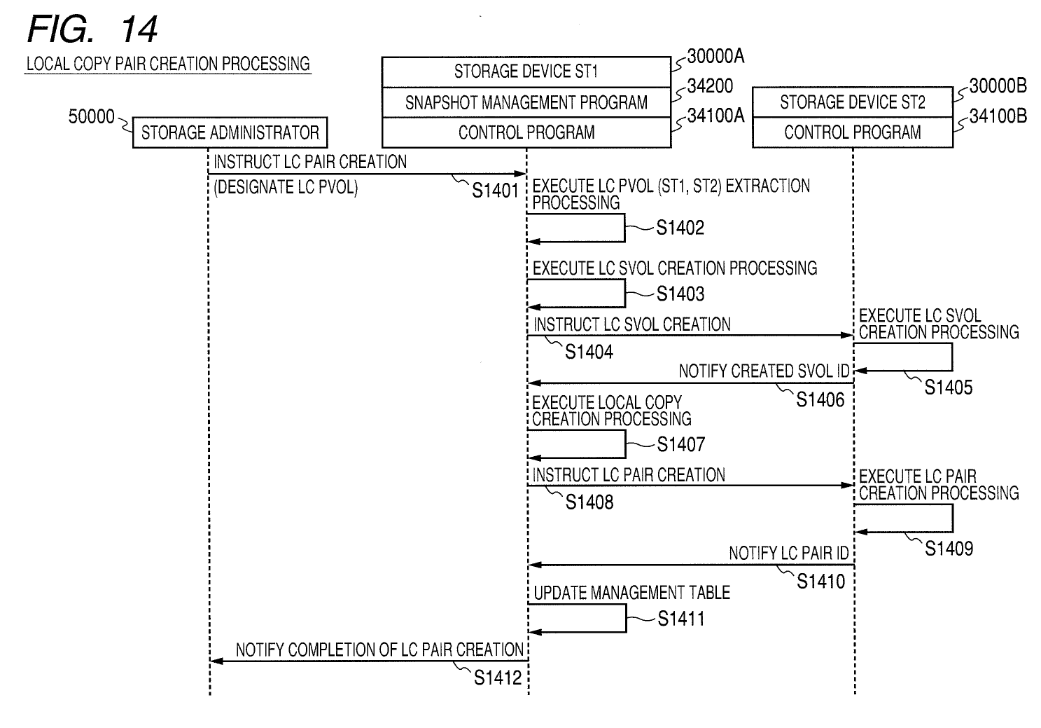

The management terminal 47000 is a terminal computer which is operated by a storage administrator 50000. To be more specific, the management terminal 47000 receives inputting such as instruction from the storage administrator 50000, and transmits the instruction or the like to the storage device 30000 or the like. Further, the management terminal 47000 provides the storage administrator 50000 with various information (for example, various notifications or the like described later in conjunction with FIG. 14 or the like).

To realize the above-mentioned function, the management terminal 47000 may include hardware substantially equal to hardware of the management computer 40000 of the first embodiment (see FIG. 5), and a memory 42000 of the management terminal 47000 may store a program substantially equal to an input/output program 42300. Here, other programs (for example, snapshot management program 42100), tables (for example, storage management table) or the like may not be stored in the memory 42000 of this embodiment.

FIG. 13 is a block diagram showing the configuration of the storage device 30000 of the second embodiment according to the present invention.

FIG. 13 shows the configuration of the storage device 30000A of this embodiment as an example.

A memory 34000 of this embodiment stores, in addition to a control program 34100A, a snapshot management program 34200, a volume management table 34300, a copy pair management table 34400 and a snapshot management table 34500.

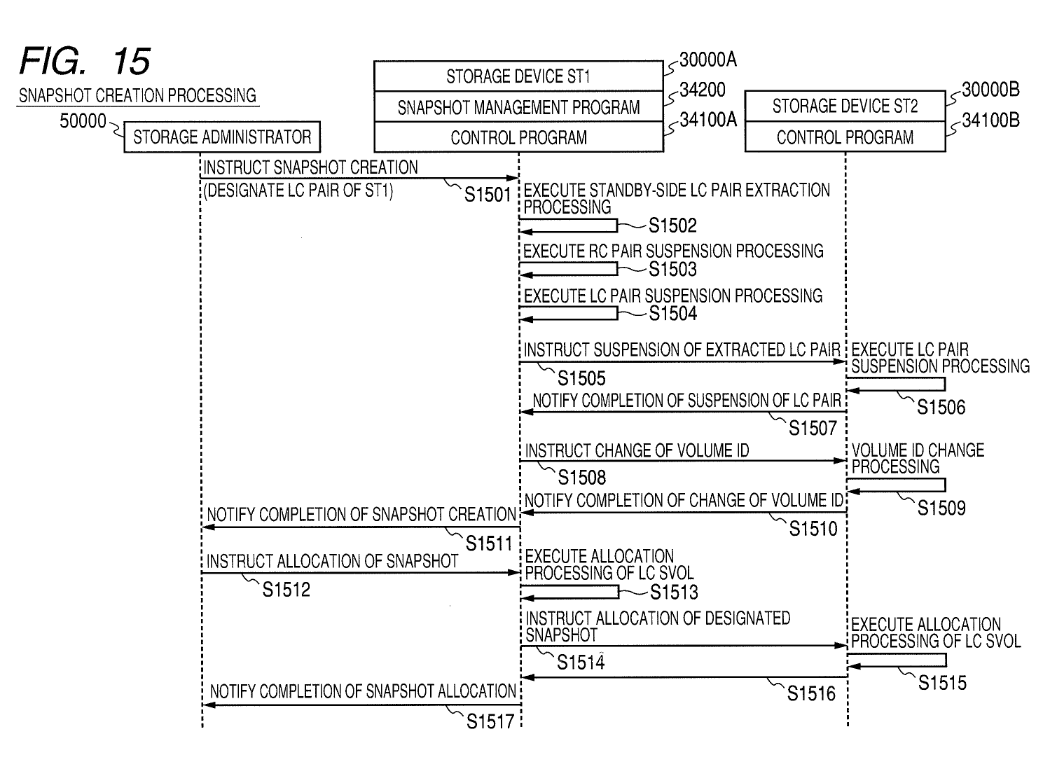

The snapshot management program 34200 is a program which is executed by a controller 32000. Accordingly, in this embodiment, processing which the snapshot management program 34200 executes is executed by the controller 32000 in an actual operation. The processing which the snapshot management program 34200 executes is described later (see FIG. 14 and FIG. 15).

The volume management table 34300, a copy pair management table 34400 and a snapshot management table 34500 are substantially equal to the volume management table 42500, the copy pair management table 42600 and the snapshot management table 42800 of the first embodiment respectively and hence, the explanation of these tables is omitted (see FIG. 7 to FIG. 9).

The configuration of the storage device 30000B of this embodiment is substantially equal to the configuration of the storage device 30000A of this embodiment. Here, in the same manner as the storage device 30000B of the first embodiment, the memory 34000 of the storage device 30000B of this embodiment stores a control program 34100B for realizing a function substantially equal to the function of the control program 34100A. Further, logical volumes 33500C and 33500D are formed in the disk device 33000 of the storage device 30000B. Here, the memory 34000 of the storage device 30000B of this embodiment may not store the snapshot management program 34200.

FIG. 14 is a sequence chart showing local copy pair creation processing executed in the second embodiment of the present invention.

This processing is executed for creating the local copy pair (in an example shown in FIG. 12, a copy pair consisting of the logical volumes 33500A and 33500B and a copy pair consisting of the logical volumes 33500C and 33500D).

Here, the local copy pair creation processing of this embodiment is basically equal to the local copy pair creation processing of the first embodiment (see FIG. 10). Here, the snapshot management program 42100 of the first embodiment is executed by the management computer 40000, while the snapshot management program 34200 of this embodiment is executed by the storage device 30000A. Accordingly, the communication between the management computer 40000 and the storage device 30000A in the first embodiment is omitted in this embodiment.

Although the local copy pair creation processing of this embodiment is explained hereinafter, the detailed explanation with respect to steps which is substantially equal to the steps in the first embodiment is omitted.

First of all, the storage administrator 50000 transmits the local copy pair creation instruction to the storage device 30000A using the management terminal 47000 (step S1401). At this point of time, a remote copy pair consisting of the logical volumes 33500A and 33500C is already created. However, it is assumed that the logical volumes 33500B and 33500D are not yet formed.

Hereinafter, as an example, the local copy pair creation processing executed for creating two local copy pairs shown in FIG. 12 is explained.

The instruction made in step S1401 includes the designation of a PVOL of the local copy pair to be created from now. For example, the storage administrator 50000 designates an identifier “ST1. VOL001” of the logical volume 33500A, and instructs the storage device 30000A to create the local copy pair including this logical volume 33500A.

The snapshot management program 34200 of the storage device 30000A which receives the instruction made in step S1401 executes local copy PVOL extraction processing (step S1402). This processing is substantially equal to the processing which is executed in step S1002 in the first embodiment and hence, the detailed explanation is omitted.

When the designated logical volume 33500A is a PVOL of the remote copy pair, it is necessary to create the local copy pair also with respect to the SVOL of the remote copy pair (see steps S1404 to S1406 and steps S1408 to S1410 described later).

Next, the control program 34100A of the storage device 30000A creates an SVOL of the local copy pair including the designated logical volume 33500A, that is, a logical volume 33500B (step S1403). An identifier of the created logical volume 33500B is “A/S1”.

Next, the snapshot management program 34200 instructs the storage device 30000A to create the SVOL of the local copy pair with respect to the SVOL of the remote copy pair corresponding to the designated logical volume 33500A (step S1404). In this example, the SVOL of the remote copy pair corresponding to the logical volume 33500A is a logical volume 33500C. Accordingly, the instruction made in step S1404 is transmitted to the storage device 30000B which includes the logical volume 33500C.

The control program 34100B of the storage device 30000B which receives the instruction made in step S1404 forms a logical volume 33500D to be formed as the SVOL of the local copy pair (step S1405), and notifies the storage device 30000A of an identifier “S/S1” of the formed logical volume 33500D (step S1406).

Next, the control program 34100A creates the local copy pair consisting of the logical volume 33500A and the logical volume 33500B (step S1407). The identifier of the created local copy pair is “2” or “3”, for example (see FIG. 8).

After the local copy pair is created, the control program 34100A stores a copy of all data stored in the PVOL of the local copy pair (that is, in the logical volume 33500A) in the SVOL (that is, in the logical volume 33500B), and a status of the local copy pair assumes “PAIR”. Thereafter, as long as the status of the local copy pair is held in “PAIR”, by storing the copy of data newly stored in the PVOL also in the SVOL, it is possible to maintain the identity between data stored in the PVOL and data stored in the SVOL.

Next, the snapshot management program 34200 instructs the storage device 30000B to create the local copy pair (step S1408). The control program 34100B of the storage device 30000B which receives this instruction creates the local copy pair consisting of the logical volume 33500C and the logical volume 33500D (step S1409), and notifies the management computer 40000 of the identifiers of the created local copy pair (“5” and “6” in the example shown in FIG. 8) (step S1410).

After the local copy pair is created, the control program 34100B stores a copy of all data stored in the PVOL of the local copy pair (that is, in the logical volume 33500C) in the SVOL (that is, in the logical volume 33500D) so that a status of the local copy pair assumes “PAIR”. Thereafter, as long as the status of the local copy pair is held in “PAIR”, by storing the copy of data newly stored in the PVOL also in the SVOL, it is possible to maintain the identity between data stored in the PVOL and data stored in the SVOL.

Here, in step S1402, when it is determined that the designated logical volume 33500A is not the PVOL of the remote copy pair, processing in steps S1404 to S1406 and processing in steps S1408 to S1410 are not executed.

Next, the snapshot management program 34200 updates a management table which the storage device 30000A holds (step S1411). The steps for updating the table and the content of the updated table are substantially equal to the steps for updating the table and the content of the updated table explained in conjunction with the first embodiment and hence, the explanation of the steps is omitted here.

Next, the snapshot management program 34200 notifies the storage administrator 50000 of the completion of the creation of the local copy pair via a management terminal 47000.

With the above-mentioned processing, the local copy pair creation processing is finished.

FIG. 15 is a sequence chart showing snapshot creation processing which is executed in the second embodiment of the present invention.

This processing is executed for creating the snapshot in the SVOL of the local copy pair. Hereinafter, as an example, the explanation is made with respect to the processing which is, in a case in which four logical volumes 33500 are formed as shown in FIG. 12, executed for creating the snapshot in the logical volumes 33500B and 33500D. At a point of time that this processing is started, both of a status of the local copy pair consisting of the logical volumes 33500A and 33500B and a status of the local copy pair consisting of the logical volumes 33500C and 33500D assume “PAIR”.

Here, the snapshot creation processing of this embodiment is basically equal to the snapshot creation processing of the first embodiment (see FIG. 11). However, different from the snapshot management program 42100 of the first embodiment which is executed by the management computer 40000, the snapshot management program 34200 of this embodiment is executed by the storage device 30000A. Accordingly, the communication between the management computer 40000 and the storage device 30000A in the first embodiment is omitted in this embodiment.

Although the snapshot creation processing of this embodiment is explained hereinafter, the detailed explanation with respect to steps substantially equal to the steps in the first embodiment can be omitted.

First of all, the storage administrator 50000 transmits snapshot creation instruction to the storage device 30000A using the management terminal 47000 (step S1501). This instruction contains the designation of the local copy pair which constitutes an object on which the snapshot is to be created. In the above-mentioned example, the local copy pair consisting of the logical volumes 33500A and 33500B is designated.

The snapshot management program 34200 of the storage device 30000A which receives the instruction made in step S1501 extracts a standby-side local copy pair on (that is, local copy pair on a storage device 30000B side in the example shown in FIG. 12) corresponding to the designated local copy pair (step S1502).

Next, the control program 34100A of the storage device 30000A suspends the remote copy pair consisting of the logical volumes 33500A and 33500C (step S1503). After the status is changed, until the pair status is changed to “PAIR” again, updating of the logical volume 33500A is not reflected on the logical volume 33500C.

Next, the control program 34100A suspends the designated local copy pair (that is, the local copy pair consisting of the logical volumes 33500A and 33500B) (step S1504). Accordingly, a copy of the content of the logical volume 33500A (that is, snapshot) at a point of time that a pair status is changed is formed in the logical volume 33500B.

Here, the timing of the suspension of the remote copy pair (step S1503) and the timing of the suspension of the local copy pair (step S1504) are substantially equal to the timing of the suspension in step S1104 and the timing of the suspension in step S1107 in the first embodiment.

Next, the snapshot management program 34200 instructs the storage device 30000B to suspend the local copy pair extracted in step S1502 (step S1505).

The control program 34100B of the storage device 30000B which receives this instruction suspends the extracted local copy pair (step S1506). Accordingly, a copy of the content of the logical volume 33500C at a point of time that a pair status is changed (that is, snapshot) is formed in the logical volume 33500D.

Here, the timing at which step S1506 is executed is substantially equal to the timing at which step S1110 in the first embodiment is executed.

Next, the control program 34100B notifies the storage device 30000A of the completion of the suspension of the local copy pair (step S1507).

Here, in the same manner as the first embodiment, after the same snapshot is created in the logical volumes 33500B and 33500D, the control program 34100A may resume the remote copy pair.

Next, the snapshot management program 34200 transmits the instruction for changing the identifier of the logical volume 33500D to the storage device 30000B (step S1508).

The control program 34100B of the storage device 30000B which receives this instruction changes the identifier of the logical volume 33500D (step S1509). After the identifier of the logical volume 33500D is changed, upon reception of the configuration information notification request from an upper computer (backup server 20000, for example), the control program 34100B responds with the changed identifier in place of the original identifier. Accordingly, the storage device 30000B may possess information (table substantially equal to the snapshot management table 34500, for example) which makes these identifiers correspond to each other.

Here, to be more accurate, the response with the changed identifier with respect to the configuration information notification request can be made after the completion of snapshot allocation processing (step S1515) described later.

Next, the control program 34100B notifies the storage device 30000A of the completion of the change of the identifier of the logical volume 33500D (step S1510).

Next, the snapshot management program 34200 notifies the storage administrator 50000 of the completion of creation of the snapshot via the management terminal 47000 (step S1511).

Next, the storage administrator 50000 transmits the instruction of allocation of the snapshot to the storage device 30000A via the management terminal 47000 (step S1512). This instruction contains information on designation of a type of the snapshot and a type of the computer to which such a snapshot is allocated. Hereinafter, the explanation is made by taking a case in which this instruction contains information on the designation that the snapshot stored in the logical volume 33500B is allocated to the backup server 20000 as an example.

The control program 34100A of the storage device 30000A which receives this instruction allocates the SVOL of the local copy in which the designated snapshot is stored (that is, logical volume 33500B) to the backup server 20000 (step S1513). The allocation processing in this embodiment is substantially equal to the allocation processing in the first embodiment (step S1118 shown in FIG. 11).

Next, the snapshot management program 34200 instructs the storage device 30000B to perform the allocation of the snapshot having the same content as the designated snapshot (step S1514). The snapshot having the same content as the designated snapshot (in other word, copy of data stored in the same logical volume at the same time) is stored in the logical volume 33500D.

The control program 34100B of the storage device 30000B which receives this instruction allocates the SVOL of the local copy which stores the snapshot having the same content as the designated snapshot (that is, logical volume 33500D) to the backup server 20000 (step S1515). The allocation processing in this embodiment is substantially equal to the allocation processing in the first embodiment (step S1120 shown in FIG. 11).

Next the control program 34100B notifies the storage device 30000A of the completion of the allocation of the logical volume 33500D (step S1516).

Next, the snapshot management program 34200 notifies the storage administrator 50000 of the completion of the allocation of the snapshot via the management terminal 47000 (step S1517).

With the above-mentioned processing, the snapshot creation processing is finished.

According to the second embodiment of the present invention described heretofore, the computer system of this embodiment which has no a management computer 40000 can also acquire the functions substantially equal to the functions of the computer system of the first embodiment.

What is claimed is:

1. A computer system comprising:
a first storage device;
a second storage device which is connected to the first storage device via a network, wherein
the first storage device includes one or more memory mediums each of which includes a plurality of storage areas for storing data, and a first controller which controls writing of data to the memory medium and reading of data from the memory medium,
the plurality of storage areas in the first storage device includes a first storage area and a second storage area,
the second storage device includes one or more memory mediums each of which includes a plurality of storage areas for storing data and a first controller which controls writing of data to the memory mediums and reading of data from the memory medium,
the plurality of storage areas in the second storage device includes a third storage area and a fourth storage area,
the first storage device is configured, upon reception of a data write request to the first storage area, to store data to which a write request is made in the first storage area, to transmit a copy of data to which the write request is made to the second storage device and to store the copy of data to which the write request is made in the second storage area,
the second storage device is configured to hold management information which contains information which makes an identifier of the first storage area and an identifier of the third storage area correspond to each other and information which makes an identifier of the second storage area and an identifier of the fourth storage area correspond to each other,
the second storage device is configured, upon reception of an inquiry of the identifier of the storage area, to transmit an identifier equal to the identifier of the first storage area as the identifier of the third storage area to the inquiry transmission source based on the management information,
the second storage device is configured, upon reception of copy of data to which the write request is made from the first storage device, to store the copy of data to which the write request is made in the third storage area and, further, to store the copy of data to which the write request is made in the fourth storage area,
the first storage device is configured, upon reception of a snapshot creation request which designates the first storage area and the second storage area, to suspend storing of the copy of data to which the write request is made in the second storage area,
the second storage device is configured, upon reception of a snapshot creation request which designates the third storage area and the fourth storage area, to suspend storing of the copy of data to which the write request is made in the fourth storage area at timing that a copy of the same data is stored in the second storage area and the fourth storage area, and
the second storage device is configured, upon reception of an inquiry of the identifier of the storage area after the suspension of storing of the copy of data to which the write request is made in the second storage area and the fourth storage area, to transmit an identifier equal to the identifier of the second storage area as the identifier of the fourth storage area to the inquiry transmission source based on the management information.

2. A computer system according to claim 1, wherein
the first storage device is configured, upon reception of the snapshot creation request, to suspend the transmission of the copy of data to which the write request is made to the second storage device, and
the first storage device is configured to suspend the storing of the copy of data to which the write request is made in the second storage area at timing that a copy of data equal to data transmitted to the second storage device is stored, and
the second storage device is configured, upon reception of the snapshot creation request, to suspend the storing of the copy of data to which the write request is made in the fourth storage area after the copy of all data transmitted before the suspension of the transmission is stored in the fourth storage area and before the transmission is resumed.

3. A computer system according to claim 1, wherein the computer system further includes a first computer and a second computer,
the first computer includes a first interface which is connected to the network, a first processor which is connected to the first interface and a first memory which is connected to the first processor,
the second computer includes a second interface which is connected to the network, a second processor which is connected to the second interface and a second memory which is connected to the second processor,
the first computer is configured to
transmit an inquiry of an identifier of the storage area to the second storage device,
transmit a data write request for writing data in the first storage area to the first storage device, and
switch the write destination of data to the third storage area when a failure occurs in the first storage device after the first computer receives an identifier equal to the identifier of the first storage area as a response to the inquiry of the identifier of the storage area, and
the second computer is configured to
transmit an inquiry of an identifier of the storage area to the second storage device,
transmit a data read request for reading data from the second storage area to the first storage device, and
switch the read destination of data to the fourth storage area when a failure occurs in the first storage device after the second computer receives an identifier equal to the identifier of the second storage area as a response to the inquiry of the identifier of the storage area.

4. A computer system according to claim 1, wherein the computer system further includes a management computer which is connected to the first storage device and the second storage device,
the management computer includes a third interface which is connected to the first storage device and the second storage device, a third processor which is connected to the third interface, and a third memory which is connected to the third processor,
the management computer is configured to hold information which makes the identifier of the second storage area and the identifier of the fourth storage area correspond to each other,
the management computer is configured to transmit the snapshot creation request to the first storage device and the second storage device,
the management computer is configured, upon reception of notification that the storing of the copy of data to which the write request is made in the second storage area and the fourth storage area is suspended from the first storage device and the second storage device respectively, to transmit an instruction of changing the identifier of the fourth storage area to an identifier equal to the identifier of the second storage area to the second storage device, and
the second storage device is configured to change the identifier of the fourth storage area to the identifier equal to the identifier of the second storage area based on the instruction.

5. A computer system according to claim 1, wherein the first storage device is configured to
hold information which makes the identifier of the second storage area and the identifier of the fourth storage area correspond to each other,
transmit the snapshot creation request to the second storage device, and
transmit to the second storage device an instruction of changing the identifier of the fourth storage area to an identifier equal to the identifier of the second storage area upon reception of notification that the storing of the copy of data to which the write request is made in the fourth storage area is suspended from the second storage device and the storing of the copy of data to which the write request is made is suspended, and
the second storage device is configured to change the identifier of the fourth storage area to the identifier equal to the identifier of the second storage area based on the instruction.

6. A method of controlling a computer system which includes a first storage device, and a second storage device which is connected to the first storage device via a network, wherein
the first storage device includes one or more memory mediums each of which includes a plurality of storage areas for storing data, and a first controller which controls writing of data to the memory medium and reading of data from the memory medium,
the plurality of storage areas in the first storage device includes a first storage area and a second storage area,
the second storage device includes one or more memory mediums each of which includes a plurality of storage areas for storing data and a first controller which controls writing of data to the memory mediums and reading of data from the memory medium,
the plurality of storage areas in the second storage device includes a third storage area and a fourth storage area,
upon reception of a data write request to the first storage area by the first storage device, data to which a write request is made is stored in the first storage area, a copy of data to which the write request is made is transmitted to the second storage device and the copy of data to which the write request is made is stored in the second storage area,
the second storage device holds management information which contains information which makes an identifier of the first storage area and an identifier of the third storage area correspond to each other and information which makes an identifier of the second storage area and an identifier of the fourth storage area correspond to each other,
upon reception of an inquiry of the identifier of the storage area by the second storage device, an identifier equal to the identifier of the first storage area is transmitted to the inquiry transmission source as the identifier of the third storage area based on the management information, and
upon reception of copy of data to which the write request is made from the first storage device by the second storage device, the copy of data to which the write request is made is stored in the third storage area and, further, the copy of data to which the write request is made is stored in the fourth storage area, wherein the method of controlling a computer system further comprising:
a first step in which, upon reception of a snapshot creation request which designates the first storage area and the second storage area by the first storage device, the first storage device suspends storing of the copy of data to which the write request is made in the second storage area,
a second step in which, upon reception of a snapshot creation request which designates the third storage area and the fourth storage area by the second storage device, the second storage device suspends storing of the copy of data to which the write request is made in the fourth storage area at timing that a copy of the same data is stored in the second storage area and the fourth storage area, and
a third step in which, upon reception of an inquiry of the identifier of the storage area after the suspension of storing of the copy of data to which the write request is made in the second storage area and the fourth storage area by the second storage device, the second storage device is allowed to transmit an identifier equal to the identifier of the second storage area as the identifier of the fourth storage area to the inquiry transmission source based on the management information.

7. A method of controlling a computer system according to claim 6, further comprising
a first step which includes a step in which upon reception of the snapshot creation request by the first storage device, the first storage device suspends the transmission of the copy of data to which the write request is made to the second storage device, and a step in which the first storage device suspends the storing of the copy of data to which the write request is made in the second storage area at timing that a copy of data equal to data transmitted to the second storage device is stored, and
a second step which includes a step in which, upon reception of the snapshot creation request by the second storage device, the second storage device suspends the storing of the copy of data to which the write request is made in the fourth storage area after the copy of all data transmitted before the suspension of the transmission is stored in the fourth storage area and before the transmission is resumed.

8. A method of controlling a computer system according to claim 6, wherein the computer system further includes a first computer and a second computer,
the first computer includes a first interface which is connected to the network, a first processor which is connected to the first interface and a first memory which is connected to the first processor,
the second computer includes a second interface which is connected to the network, a second processor which is connected to the second interface and a second memory which is connected to the second processor,
the method of controlling the computer system further comprises:
a step in which the first computer transmits an inquiry of an identifier of the storage area to the second storage device;
a step in which the first computer transmits a data write request for writing data in the first storage area to the first storage device; and
a step in which the first computer switches the write destination of data to the third storage area when a failure occurs in the first storage device after the first computer receives an identifier equal to the identifier of the first storage area as a response to the inquiry of the identifier of the storage area;
a step in which the second computer transmits an inquiry of an identifier of the storage area to the second storage device;
a step in which the second computer transmits a data read request for reading data from the second storage area to the first storage device; and
a step in which the second computer switches the read destination of data to the fourth storage area when a failure occurs in the first storage device after the second computer receives an identifier equal to the identifier of the second storage area as a response to the inquiry of the identifier of the storage area.

9. A method of controlling a computer system according to claim 6, wherein the computer system further includes a management computer which is connected to the first storage device and the second storage device,
the management computer includes a third interface which is connected to the first storage device and the second storage device, a third processor which is connected to the third interface, and a third memory which is connected to the third processor,
the management computer holds information which makes the identifier of the second storage area and the identifier of the fourth storage area correspond to each other, and
the method of controlling a computer system further comprises:
a step in which the management computer transmits the snapshot creation request to the first storage device and the second storage device; and
a step in which, upon reception of notification that the storing of the copy of data to which the write request is made in the second storage area and the fourth storage area is suspended from the first storage device and the second storage device respectively, the management computer transmits an instruction of changing the identifier of the fourth storage area to an identifier equal to the identifier of the second storage area to the second storage device, and
the third step includes a step in which the second storage device switches the identifier of the fourth storage area to the identifier equal to the identifier of the second storage area based on the instruction.

10. A method of controlling a computer system according to claim 6, wherein the first storage device holds information which makes the identifier of the second storage area and the identifier of the fourth storage area correspond to each other, and
the method of controlling the computer system further comprises:
a step in which the first storage device transmits the snapshot creation request to the second storage device; and
a step in which the first storage device transmits an instruction of changing the identifier of the fourth storage area to an identifier equal to the identifier of the second storage area upon reception of notification that the storing of the copy of data to which the write request is made in the fourth storage area is suspended from the second storage device and upon suspension of the storing of the copy of data to which the write request is made, and
the third step includes a step in which the second storage device switches the identifier of the fourth storage area to the identifier equal to the identifier of the second storage area based on the instruction.
